(19) United States
(12) Patent Application Publication
(10) Pub. No.: US 2023/0398514 A1
(43) Pub. Date: Dec. 14, 2023

(54) HYDROTHERMAL REACTOR SYSTEMS AND METHODS

(71) Applicant: University of Washington, Seattle, WA (US)

(72) Inventors: Igor V. Novosselov, Seattle, WA (US); Brian Pinkard, Seattle, WA (US); Stuart Moore, Seattle, WA (US)

(73) Assignee: University of Washington, Seattle, WA (US)

(21) Appl. No.: 18/034,583

(22) PCT Filed: Oct. 27, 2021
(86) PCT No.: PCT/US2021/056832

§ 371 Date: Apr. 28, 2023

Related U.S. Application Data
(60) Provisional application No. 63/107,418, filed on Oct. 29, 2020.

(51) Int. Cl. B01J 19/26; B01J 19/00; C02F 1/72; C02F 1/74; C02F 11/08

(52) U.S. Cl. CPC B01J 19/26; B01J 19/0013; C02F 1/722; C02F 1/74; C02F 11/086; B01J 2219/00063; C02F 2209/02; C02F 2101/306

(57) ABSTRACT

Disclosed herein are embodiments of a hydrothermal reactor, such as a downflow hydrothermal reactor and methods of using the same. Also disclosed herein are system embodiments comprising the hydrothermal reactor. Method embodiments disclosed herein facilitate determining operation parameters for the hydrothermal reactor that give rise to efficient feedstock conversion to products while maintaining integrity of the reactor (e.g., avoiding corrosion) and providing safe operating conditions. The disclosed reactor and system embodiments facilitate situations where small scale and/or remote destruction of feedstocks (e.g., chemical warfare agents and/or environmental toxins) is needed.

### CROSS REFERENCE TO RELATED APPLICATION

This application claims the benefit of the earlier filing date of U.S. Provisional Application No. 63/107,418, filed on Oct. 29, 2020, the entirety of which is incorporated herein by reference.

### ACKNOWLEDGMENT OF GOVERNMENT SUPPORT

This invention was made with government support under Grant No. HDTRA1-17-1-0001, awarded by the Defense Threat Reduction Agency. The government has certain rights in the invention.

### FIELD

The present disclosure provides system and method embodiments for maintaining stable operation of a hydrothermal reactor facilitating a chemical reaction of known or unknown reaction kinetics and enthalpic changes.

### BACKGROUND

Supercritical Water Oxidation (SCWO) is a process where oxidative reaction mechanisms are used to mineralize a target feedstock within the supercritical phase of water. The oxidative reaction mechanisms are primarily driven by OH and HO₂ radicals, generated through the addition of O₂, air, H2O₂, or another oxidative radical source. The SCWO process has been used to oxidize and mineralize various feedstocks. SCWO is viewed as a significant improvement over conventional incineration for waste disposal, as SCWO does not produce NOₓ, SO₂, aerosolized particulate matter, or other hazardous emissions.

Industrial-scale SCWO reactors typically fall into one of two general design categories: vessel-type or tubular reactors. Attempts in the art to commercialize the SCWO process have been hindered by the need to simultaneously solve the significant technical challenges of (i) reactor control, (ii) corrosion, (iii) plugging/scaling, (iv) component/hardware costs, and (v) process economics, particularly considering the value of the waste destruction service. Multiple efforts to use SCWO for the destruction of sewage sludge have led to several failed commercialization efforts, largely due to some combination of the challenges listed above. There exists a need in the art for new reactor designs, systems implementing such reactors, and operational parameters that can be used to fallbacks and limitations of conventional SCWO reactors/methods.

### SUMMARY

Disclosed herein are embodiments of a downflow hydrothermal reactor, comprising: (a) a first zone configured for contacting a reactant with a volume of water under supercritical conditions to form a product and/or destroy a compound, wherein the first zone comprises a pressure vessel having a distal end and a proximal end; a co-axial nozzle configured to deliver a fuel and an oxidant into a reagent introduction portion; and a reagent feedstock introduction portion positioned at the proximal end of the pressure vessel, wherein reagent feedstock introduction portion comprises (i) an opening configured to accept the co-axial nozzle, (ii) one or more reagent feedstock inlets positioned at the proximal end of the pressure vessel and that are configured to deliver a reagent feedstock into a primary reaction zone of the pressure vessel, and (iii) one or more ports configured to introduce one or more thermocouples into the reagent feedstock introduction region and/or one or more connections configured to couple a thermowell to the reagent feedstock introduction region; (b) a second zone configured for dissolving solids in a volume of water in liquid phase, wherein the second zone is located downstream of the first zone with respect to reagent feedstock flow and wherein the second zone comprises one or more injection ports positioned at the distal end of the pressure vessel configured to introduce a liquid effluent and/or a quenching solution into the pressure vessel; one or more outlets configured to eject effluent from the hydrothermal reactor; and

a effluent ejection portion positioned at the distal end of the pressure vessel; and (c) a plurality of thermocouples and/or thermowells that are physically associated with the downflow hydrothermal reactor at exterior locations between the distal end and the proximal end of the pressure vessel in the first zone.

In some embodiments, the reactor further comprises a replaceable liner component that is made of titanium. In any or all of the above embodiments, the co-axial nozzle comprises an inner tube region that delivers the fuel into the downflow hydrothermal reactor and an outer tube region that delivers the oxidant into the downflow hydrothermal reactor. In any or all of the above embodiments, the one or more reagent feedstock inlets are connected to a reagent feedstock supply, wherein the reagent feedstock supply comprises biomass, sewage sludge, a chemical warfare agent, a chemical warfare agent hydrolysate, a per- or polyfluoroalkyl substance, a pesticide, an industrial effluent, an environmental contaminant, or a combination thereof. In any or all of the above embodiments, the first zone is maintained at a temperature of 374° C. to 800° C. and a pressure of at least 22 MPa. In any or all of the above embodiments, the reagent feedstock introduction portion is detachable from the pressure vessel and/or the effluent ejection portion is detactable from the pressure vessel. In any or all of the above embodiments, the downflow hydrothermal reactor is portable and/or wherein the second zone further comprises one or more ports configured to introduce one or more thermocouples into the second zone.

Also disclosed herein are embodiments of a system, comprising: a portable downflow hydrothermal reactor comprising (a) a first zone configured for contacting a reactant with a volume of water under supercritical conditions to form a product and/or destroy a compound, wherein the first zone comprises a pressure vessel having a distal end and a proximal end; a co-axial nozzle configured to deliver a fuel and an oxidant into a reagent introduction portion; and a reagent feedstock introduction portion positioned at the proximal end of the pressure vessel, wherein the reagent feedstock introduction portion comprises (i) an opening configured to accept the co-axial nozzle, (ii) one or more reagent feedstock inlets positioned at the proximal end of the pressure vessel and that are configured to deliver a reagent feedstock into a primary reaction zone of the pressure vessel, and (iii) one or more ports configured to introduce one or more thermocouples into the reagent feedstock introduction region and/or one or more connections configured to couple a thermowell to the reagent feedstock introduction region; (b) a second zone configured for dissolving solids in a volume of water in liquid phase, wherein the second zone is located downstream of the first zone with respect to reagent feedstock flow and wherein the second zone comprises one or more injection ports positioned at the distal end of the pressure vessel configured to introduce a liquid effluent and/or a quenching solution into the pressure vessel; one or more outlets configured to eject effluent from the hydrothermal reactor; and a effluent ejection portion positioned at the distal end of the pressure vessel; and (c) a plurality of thermocouples and/or thermowells that are physically associated with the downflow hydrothermal reactor at a fuel source fluidly coupled to the co-axial nozzle; an oxidant source fluidly coupled to the co-axial nozzle; a reagent feedstock source; a fluid source comprising water; one or more pumps;

one or more sensors for monitoring components of the system; and one or more actuators for controlling components of the system. In any or all of the above embodiments, the system further comprises a preprocessing unit comprising a solids filter or elutriator configured to separate solids from the reagent feedstock source prior to introducing reagent feedstock into the downflow hydrothermal reactor.

In any or all of the above embodiments, the one or more ports of the reagent feedstock introduction portion comprises a first port and a second port and the one or more thermocouples of the reagent feedstock introduction portion comprises a first thermocouple and a second thermocouple, wherein the first port is coupled to the first thermocouple and the second port is coupled to the second thermocouple and wherein the first thermocouple is positioned so as to measure a temperature of fluid at the proximal end of the pressure vessel and wherein the second thermocouple is positioned so as to measure a temperature of fluid in the primary reaction zone of the pressure vessel. In any or all of the above embodiments, the one or more ports of the effluent ejection portion comprises a first port and the one or more thermocouples of the effluent ejection portion comprises a first thermocouple, wherein the first port is coupled to the first thermocouple, wherein the first thermocouple is positioned so as to measure a temperature of the effluent. In any or all of the above embodiments, the one or more sensors are configured to measure (i) temperatures detected by the one or more thermocouples of the reactant introduction portion and/or the effluent ejection portion; (ii) pH of fluids contained within the downflow hydrothermal reactor; and/or (iii) chemical make-up of fluids contained within and/or ejected from the downflow hydrothermal reactor. In any or all of the above embodiments, the system comprises the quenching solution and the quenching solution comprises a base, and wherein the system further comprising a quenching solution source fluidly coupled to the one or more injection ports positioned at the distal end of the pressure vessel. In any or all of the above embodiments, the actuators are configured to control fuel and/or oxidant flow rates and/or injection frequency; reagent feedstock flow rate and/or injection frequency; quenching solution flow rate and/or injection frequency; neutralizing agent introduction into the quenching solution; or a combination thereof. In any or all of the above embodiments, the co-axial nozzle comprises an inner tube region configured to deliver a fuel into the downflow hydrothermal reactor and an outer tube region configured to deliver an oxidant into the downflow hydrothermal reactor.

Also disclosed herein are embodiments of a method of using the downflow hydrothermal reactor system of claim 8 for supercritical water oxidation, comprising: introducing an oxidant into the downflow hydrothermal reactor through an outer tube region of the co-axial nozzle; introducing a fuel into the downflow hydrothermal reactor through an inner tube region of the co-axial nozzle; igniting the fuel; and monitoring (i) temperatures detected by the one or more thermocouples of the reactant introduction portion and/or the effluent ejection portion; (ii) pH of fluids contained within the downflow hydrothermal reactor; and/or (iii) chemical make-up of fluids contained within and/or ejected from the downflow hydrothermal reactor using the one or more sensors. In any or all of the above embodiments, the method further comprises:

(i) using one of the one or more actuators to adjust flow rate and/or injection frequency of the oxidant; (ii) using one of the one or more actuators to adjust flow rate and/or injection frequency of the fuel so as to control the position of the primary reaction zone within the pressure vessel; (iii) using one of the one or more actuators to adjust flow rate and/or injection frequency of the reagent feedstock so as to control an oxidation process that occurs within the pressure vessel, or to control temperature of the first zone, and/or or to control reagent feedstock temperature as reagent feedstock enters the downflow hydrothermal reactor such that the temperature is maintained below hydrolysis temperature to avoid plugging; (iv) using one of the one or more actuators to adjust flow rate and/or injection frequency of the quenching solution so as to factilitate transition of supercritical water in the pressure vessel to liquid compressed water, thereby dissolving by-products from the supercritical water in the liquid compressed water; (v) pretreating the reagent feedstock by treating the reagent feedstock with an effluent produced by the downflow hydrothermal reactor and/or filtering solids from the reagent feedstock; or (vi) any combination of (i)-(iv). In any or all of the above embodiments, the fuel comprises an alcohol; an alcohol and water mixture; a liquid fuel selected from gasoline, kerosene, and/or diesel; or a liquid fuel and water mixture, wherein the liquid fuel is selected from gasoline, kerosene, and/or diesel. In any or all of the above embodiments, the method further comprises desalinating and/or recycling any water from the effluent. In any or all of the above embodiments, the reagent feedstock comprises biomass, sewage sludge, a chemical warfare agent, a chemical warfare agent hydrolysate, a per- or polyfluoroalkyl substance, a pesticide, an industrial effluent, an environmental contaminant, or a combination thereof. The foregoing and other objects and features of the present disclosure will become more apparent from the following detailed description, which proceeds with reference to the accompanying figures.

### BRIEF DESCRIPTION OF THE DRAWINGS

FIG. 1 illustrates an external view of the outside of a representative downflow hydrothermal reactor embodiment.

FIG. 2 illustrates an internal view of the inside of a representative downflow hydrothermal reactor embodiment.

FIG. 3 shows a view of the end of a co-axial nozzle embodiment which is inserted into a downflow hydrothermal reactor.

FIG. 4 is a zoomed view of the top of a downflow hydrothermal reactor embodiment showing components of a reagent feedstock introduction portion of the reactor.

FIG. 5 is a zoomed view of the bottom of a downflow hydrothermal reactor embodiment showing components of an effluent ejection portion of the reactor.

FIG. 6 is a schematic diagram of a representative downward-flow SCWO reactor and system embodiment, wherein air can be used as an oxidant.

FIG. 7 is an illustration of a representative mobile system embodiment disclosed herein that can be used to analyze a reagent feedstock (e.g., a feedstock taken from a source comprising a chemical warfare agent) at a remote location.

FIG. 8 is a flow diagram showing a representative flow scheme of a representative system embodiment as disclosed herein.

FIG. 9 is a control diagram showing a representative control scheme that can be used to control components of a representative system embodiment disclosed herein.

FIG. 10 is a operation diagram showing a representative remote operation scheme that can be used to remotely control and operate components of a representative system embodiment disclosed herein.

FIGS. 11A-11D provide Raman spectra showing results obtained during operation of a downflow hydrothermal reactor embodiment disclosed herein, showing the progress as the reactor destroys dimethyl methylphosphonate or “DMMP” (a CWA surrogate chemical) introduced therein, wherein FIG. 11A shows a 2 wt % DMMP Baseline; FIG. 11B shows an H₂O baseline; FIG. 11C shows 2 wt % DMMP at 675° C.; and FIG. 11D shows a zoomed-in region of FIG. 11C.

FIG. 12 summarizes results obtained from using a representative downflow hydrothermal reactor to destroy DMMP, which compares destruction efficienty with trends in CO emission, reactor temperature, and excess air.

FIG. 13 is a graph showing results obtained from using a representative downflow hydrothermal reactor to destroy DMMP at different operation temperatures.

FIGS. 14A and 14B show schematic diagrams of two embodiments of representative downward-flow SCWO reactor and other system components according to the present disclosure, with a small form factor optimized for use on a mobile platform.

FIG. 15 is a graph summarizing reactor temperatures measurements as a function of air-fuel ratio ( ϕ_{AF}) and varied fuel concentration obtained from a system embodiment wherein a thermocouple or “TC” (e.g., TC 3) is positioned 25 mm from the nozzle; the dashed line indicates the critical temperature (374° C).

FIG. 16 is a graph summarizing thermocouple measurements during steady-state operation with ϕ_{AF}=1.1 and varying concentrations of ethanol for a system embodiment wherein a TC (e.g., TC 3) is used to measure steady-state temperatures at two separate locations during two separate runs; the dashed line represents the critical temperature (374° C).

FIG. 17 is a graph summarizing external reactor wall temperatures using external TCs (e.g., TC 6 and TC 8) at varied fuel dilutions and constant ϕ_{AF}=1.1 with internal reactor temperature measured using an internal TC (e.g., TC 3) for reference.

FIG. 18 shows representative Raman spectra monitoring the effluent of an alkaline hydrolysis reactor processing DMMP, wherein peak heights can be directly and automatically correlated with product yields for integration in a feedback control algorithm.

### DETAILED DESCRIPTION

### General Considerations

All of the features disclosed in this specification (including any accompanying claims, abstract, and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract, and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods, systems, and apparatus can be used in conjunction with other systems, methods, and apparatus.

As used herein, the terms “a,” “an,” and “at least one” encompass one or more of the specified element. That is, if two of a particular element are present, one of these elements is also present and thus “an” element is present. The terms “a plurality of” and “plural” mean two or more of the specified element.

As used herein, the term “and/or” used between the last two of a list of elements means any one or more of the listed elements. For example, the phrase “A, B, and/or C” means “A,” “B,” “C,” “A and B,” “A and C,” “B and C,” or “A, B, and C.” As used herein, the term “coupled” generally means physically coupled or linked, unless specified otherwise, and does not exclude the presence of intermediate elements between the coupled items absent specific contrary language.

Directions and other relative references (e.g., inner, outer, upper, lower, etc.) may be used to facilitate discussion of the drawings and principles herein, but are not intended to be limiting. For example, certain terms may be used such as “inside,” “outside,”, “top,” “down,” “interior,” “exterior,” and the like. Such terms are used, where applicable, to provide some clarity of description when dealing with relative relationships, particularly with respect to the illustrated embodiments. Such terms are not, however, intended to imply absolute relationships, positions, and/or orientations, excluding references to a “downflow hydrothermal reactor” which is intended to have a specific orientation as described herein. As used herein, “and/or” means “and” or “or,” as well as “and” and “or.”

As used herein, with reference to the pressure vessel described herein, “proximal” refers to a position, direction, or portion of the pressure vessel that is closer to where reagent feedstock enters the downflow hydrothermal reactor, while “distal” refers to a position, direction, or portion of the pressure vessel that closer to the area of the pressure vessel where effluent is expelled.

Unless explained otherwise, all technical and scientific terms used herein have the same meaning as commonly understood to one of ordinary skill in the art to which this disclosure belongs. Although methods and compounds similar or equivalent to those described herein can be used in the practice or testing of the present disclosure, suitable methods and compounds are described below. The compounds, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

### Introduction

Supercritical Water Oxidation (SCWO) is a process where oxidative reaction mechanisms are used to mineralize a target feedstock within the supercritical phase of water, which typically is defined in the art as having temperatures and pressures exceeding 374° C. and 22.1 MPa, respectively. The vessel-type or tubular reactors that exist in the art rely on oxidative reactions to destroy the target waste, with typical operating temperatures up to 650° C. and typical reaction residence times of >8 seconds. Higher reaction temperatures are desired to ensure complete mineralization of the target waste but are limited by safe operating temperature limits of the materials used to construct reactor walls. Most commercial deployments of SCWO technologies are large sized reactors (often the size of a shipping container or larger), with waste flow rates >3 gallons per minute (GPM). Systems of this size are typically capital intensive (>$4M+) and require high waste throughputs to justify the capital expenditure. Systems of this size do not well serve small-volume waste producers and the type of waste feedstocks (e.g., hazardous waste feedstocks) used with SCWO are expensive or dangerous to ship to a central processing facility. As such, a low-cost SCWO system that can be deployed and operated on-site would be more desirable for small-scale producers.

One promising application for SCWO technology is the destruction of recalcitrant, hazardous wastes, such as chemical warfare agents (CWA) hydrolysates or industrial effluents. Process economics tend to be better, but such wastes have high quantities of salts and heteroatoms, and inconsistent or unknown heating values, exacerbating issues of reactor control, corrosion, and plugging. To implement SCWO for hazardous waste destruction, corrosion and plugging control strategies have been proposed (e.g., transpiring wall reactors), which typically require well-characterized system performance. Additionally, automated reactor control requires a thorough understanding of system dynamics and performance under a wide range of conditions for safe thermal management. The high SCWO temperatures and pressures used with conventional systems require large systemic energy inputs to achieve. Heating is typically accomplished by (i) external heating (e.g., with a radiant furnace), (ii) internal heating from the fuel value of the feedstock, and/or (iii) internal heating with a pilot fuel (e.g., diesel, ethanol, isopropanol, etc.). Preheating the reactor inlets with resistive or radiant heaters is common on most SCWO systems to generate high enough temperatures to ensure continuous, autothermal operation. SCWO heating (and cooling) strategies tend to have slow response times with regards to influencing the overall system behavior, thus predictive control strategies are usually needed to ensure safe operating conditions within the SCWO system.

Piloted reactor designs can be employed for efficient internal heating and stabilization of SCWO reactors. The choice to use a pilot fuel (e.g., ethanol, kerosene, jet fuel such jet A, gasoline, etc.) and fuel flow rates is highly dependent on the targeted feedstock, as a feedstock with high energy value (e.g., sewage sludge) typically does not require a pilot fuel, while destruction of hazardous waste typically does. The use of pilot fuel is challenging, as viable pilot fuels typically have characteristic SCWO reaction times that are much faster than the waste stream being destroyed. Poorly tuned injection flow profiles or fuel concentrations can create dangerous hot zones within the reactor leading to high thermal gradients. Computational fluid dynamics (CFD) simulations can, in theory, be leveraged to design a well-controlled SCWO reactor operating with a pilot fuel. However, the accuracy of CFD simulations must be verified through experimental validation, especially when one or more reactor inlet enters as a subcritical fluid, as the transition of a substance across the critical point and the inter-phase behavior are challenging to model.

The present disclosure provides a system and method for maintaining stable operation of a hydrothermal reactor facilitating a chemical reaction of known or unknown reaction kinetics and enthalpic changes. In some embodiments, the hydrothermal reactor and system embodiments described herein can, with any suitable modifications to components, be used for methods involving SCWO, supercritical water gasification (“SCWG”), or other processes where the reaction medium is primarily supercritical or hot-compressed water. SCWG is a technology that can convert wet biomass or heterogeneous organic waste to light fuel gases, including H₂ and CH₄. SCWG leverages the beneficial mass transfer properties to rapidly dissolve and decompose organic matter, with low yields of CO due to the high activity of the water-gas shift reaction. In particular embodiments, the hydrothermal reactor and system embodiments are used for SCWO. In some embodiments, the hydrothermal reactor and system embodiments are used for a SCWO method that neutralizes or destroys hazardous wastes, including chemical warfare agents and per- and polyfluoroalkyl substances (“PFAS”).

In the presently disclosed method and reactor/system embodiments, local temperatures, systemic pressure, effluent composition, local concentration of a key reaction intermediate or final product, and other process variables can be monitored using sensors coupled with the reactor to control actuators of the system, such as (but not limited to) actuators that control heaters, pumps, flow rates, injection frequency, and the like, to thereby promote a desired level of reagent feedstock conversion to the corresponding final product, while preventing unsafe operating conditions. In particular embodiments, the hydrothermal reactor can be coupled with various temperature monitoring components, such as thermocouples and/or thermowells, to monitor temperatures within various locations of the reactor and/or at various external locations of the reactor. The unique combination of temperature monitoring components, sensors, and actuators, paired with components of the reactor itself, can aid in increasing reactor output/activity while also maintaining safety and avoiding typical drawbacks of conventional reactor systems, such as fouling and corrosion. In particular embodiments, the system comprises a small-scale downflow hydrothermal reactor that is portable and thus can be moved to and from various locations, including laboratories and/or waste disposal sites. In particular embodiments, the downflow hydrothermal reactor can be operated with a pilot fuel, such as an alcohol (e.g., methanol, ethanol, isopropanol, and the like), or other liquid fuels (e.g., gasoline, kerosene, diesel, and the like). In an independent embodiment, gaseous fuels (e.g., methane, ethane, propane, natural gas, and other suitable gases) can be used In particular embodiments, the downflow hydrothermal reactor can be operated with an oxidant, such as H₂O₂, air, O₂, or another oxidative radical source.

### Reactor and System Embodiments

Disclosed herein are embodiments of a downflow hydrothermal reactor for use in hydrothermal refining methods wherein feedstocks comprising reagents of interest are reacted under conditions using supercritical water to the reagents to oxidized species that can be isolated and/or neutralized. In particular embodiments, the downflow hydrothermal reactor is used in a system that is set-up for carrying out reactions using supercritical water, such as SCWO, SCWG, and other regimes. In particular embodiments, the downflow hydrothermal reactor comprises a design and configuration of components that facilitates its use as a small, portable, low-cost platform for destroying/neutralizing undesired reagents, including (but not limited to) chemical warfare agents and per- and polyfluoroalkyl substances. In some embodiments, the reactor can be modified to be a large-scale reactor by changing dimensions of components used in the reactor. In some embodiments, the hydrothermal reactor is any reactor operating at temperature in the range of 374° C. to 1000° C. (e.g., 374° C. to 900° C., or 374° C. to 800° C.) and pressure in the range of 0.1 to 50 MPa, wherein a primary working fluid and/or reaction medium is water. Water may or may not participate (e.g., as a reactant) in the reactions performed out in the reactor. In some embodiments, water is not a reactant in a reaction performed in the reactor. In some other embodiments, water is a reactant in a reaction performed in the reactor.

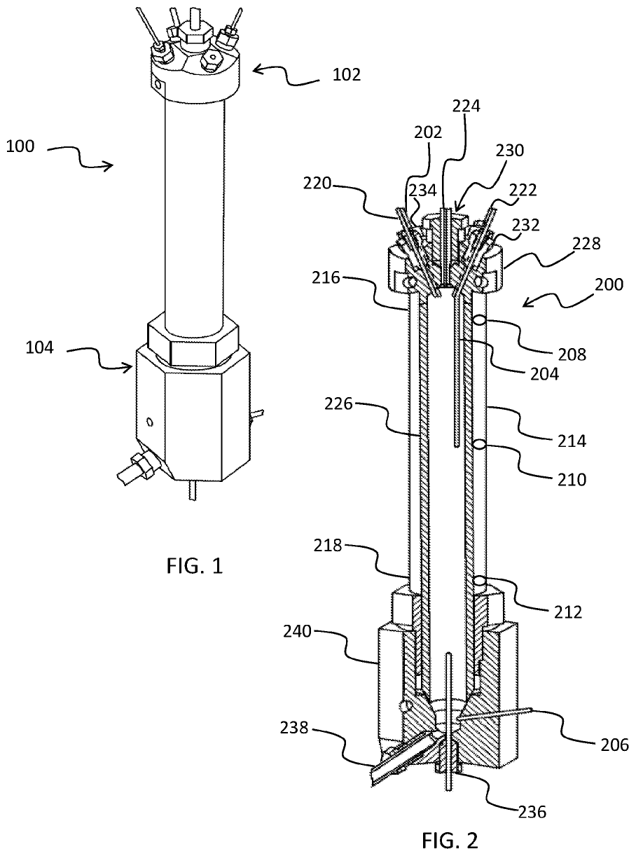

The downflow hydrothermal reactor of the present disclosure typically comprises two zones, as shown in the reactor illustrated in FIG. 1 (reactor 100): a first zone (102) configured for contacting a reagent from a feedstock with a volume of water under supercritical conditions to form a product under improved reaction conditions; and a second zone (104) configured for dissolving solids produced in the first zone in a volume of water in liquid phase. In particular embodiments, a first zone is provided, which is configured for contacting a reagent from a feedstock with a volume of water under supercritical conditions to form a product (or otherwise destroy a recalcitrant compound or species), such as one or more oxidized products. In particular embodiments, the downflow hydrothermal reactor comprises a pressure vessel having a distal end and a proximal end; a liner component positioned within the pressure vessel; a co-axial nozzle configured to deliver a fuel and an oxidant into a reagent introduction portion; and a reagent feedstock introduction portion positioned at the proximal end of the pressure vessel and above the liner component. The reagent feedstock introduction portion comprises an opening configured to accept the co-axial nozzle, one or more reagent feedstock inlets positioned at the proximal end of the pressure vessel and that are configured to deliver a reagent feedstock into a primary reaction zone of the pressure vessel, and one or more ports configured to introduce one or more thermocouples into the reagent feedstock introduction region. In some embodiments, instead of introducing thermocouples into the reagent feedstock introduction region, one or more thermowells can be coupled to this region. The reagents can include, but are not limited to, organic reagents, such as chemical warfare agents (or hydrolsates thereof), such as sarin (or “GB”), mustard gas (or “HD”), and the like), or a surrogate thereof (e.g., dimethyl methylphosphonate or “DMMP”); environmental contaminants, such as per- and polyfluoroalkyl substances; and other toxic materials/chemicals. Under the supercritical conditions used to operate the reactor, the organic compounds and oxygen become fully miscible in water, allowing oxidation to occur in a single fluid phase thereby facilitating transport through the reactor, fast mixing, and fast reactions.

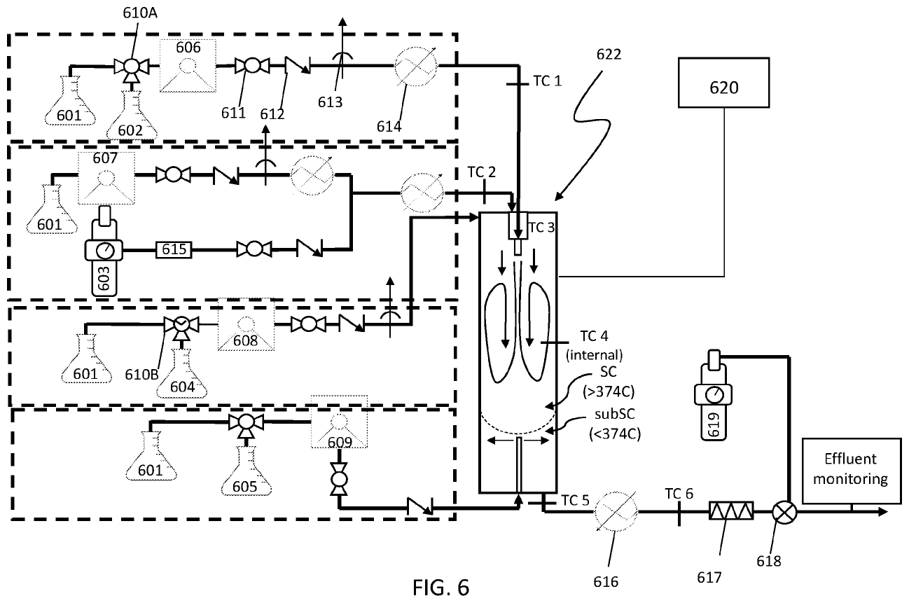

The downflow hydrothermal reactor can further comprise one or more temperature monitoring components, such as thermocouples that are positioned within the first zone of the reactor and/or the second zone of the reactor to obtain temperature measurements. In some embodiments, ports are provided in the reagent feedstock introduction portion of the reactor to facilitate placing thermocouples therein. In other embodiments, thermowells can be used for temperature sensing. Thermowells can be used in embodiments where it is not desirable to have direct contact between a thermocouple and any working fluid. The reactor can further comprise a plurality of additional thermocouples or thermowells that are physically associated (e.g., attached directly or indirectly to so as to be in sufficient contact to allow temperature detection) with the reactor at exterior locations between the distal end and the proximal end of the pressure vessel. An exemplary embodiment is illustrated in FIG. 2. As shown in FIG. 2, embodiments of the reactor (e.g., reactor 200) can comprise three internal thermocouples (such as Type-K TCs 202, 204, and 206) and three external thermocouples (e.g., Type-K TCs 208, 210, and 212). As shown in FIG. 2, one of the thermocouples can be positioned within the reactant feedstock introduction portion of the reactor (e.g., TC 202, which protrudes 1-2 mm into the reactant feedstock introduction portion) to measure fluid temperature at the top of the reactor. A second thermocouple (e.g., TC 204) is also inserted into the reactor. This thermocouple can protrude further into the reactor (e.g., 178 mm down) and can be bent so as to sit near the wall of the reactor and limit interference with the flow dynamics from the co-axial nozzle. The reactor further comprises the external thermocouples 208, 210, and 212, which can be used to monitor the wall temperatures of the reactor to keep it from exceeding the reactor material's thermal capabilities. FIG. 2 also shows the following components: pressure vessel 214, having proximal and distal ends, 216 and 218, respectively; reagent introduction inlets 220 and 222; co-axial nozzle 224; liner component 226; reagent feedstock introduction portion 228; opening 230 configured to accept the co-axial nozzle; ports 232 and 234 configured to introduce thermocouples; injection port 236 positioned at distal end 218 of pressure vessel 214; outlet 238; and effluent ejection portion 240. In particular embodiments, the wall temperatures are measured near the same location as the internal thermocouples to gather information on the difference in internal vs. external reactor temperatures, which can help predict how hot the reactor can be safely run. In additional embodiments, influent lines used to introduce materials in to the reactor can be instrumented with internal thermocouples (e.g., Type-K thermocouples), as shown in FIG. 6 (labeled as “TC 1” and “TC 2”), which is a schematic diagram showing an exemplary system configuration. The thermocouples can be monitored during operation to facilitate characterization of the reactor thermal profile under steady-state operating conditions and thermal response time during dynamic operation.

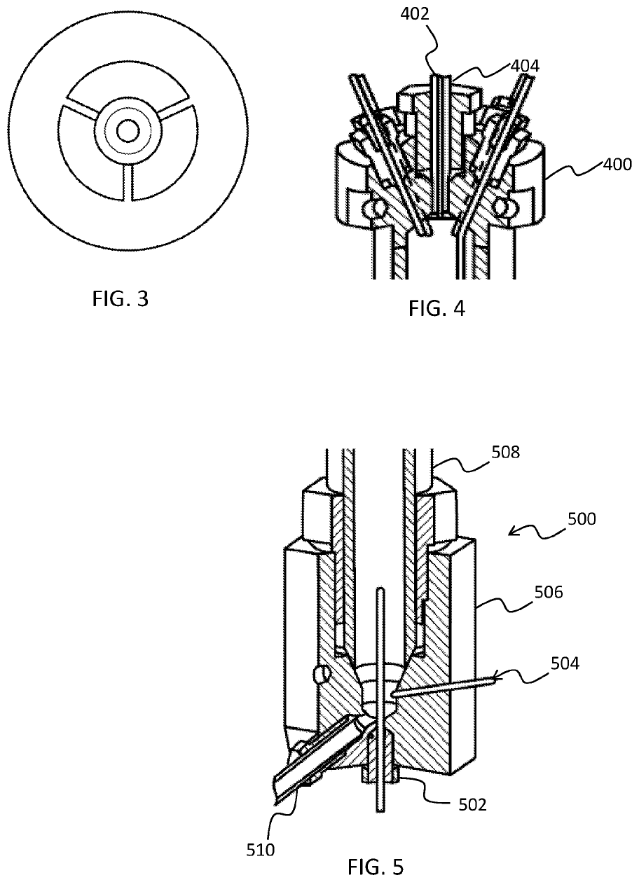

The pressure vessel and other components of the reactor typically are made of an austentinitic nickel-chromium-based superalloy, such as an Inconel® material (e.g., Inconel® 625). In some embodiments, the pressure vessel have an internal volume of 164 mL. In some embodiments, the pressure vessel has an internal diameter of 25.4 mm and an outer diameter of 38.1 mm. In some embodiments, the pressure vessel is welded to the reagent introduction portion of the reactor. In yet other embodiments, the pressure vessel is detachable from the reagent introduction portion of the reactor. The liner component of particular reactor embodiments typically is a liner that can be replaced and that is made out of titanium or other metals or alloys thereof, or that is made out of a ceramic material (e.g., Al₂O₃). In some embodiments, the titanium liner has an inner diameter of 24.25 mm. The co-axial nozzle comprises an inner tube region that delivers the fuel into the downflow hydrothermal reactor and an outer tube region that delivers the oxidant into the downflow hydrothermal reactor. In particular embodiments, the co-axial nozzle comprises three fuse-welded Inconel® 625 spacers that center the inner tube region within the outer tube region, as shown in FIG. 3. In some embodiments, the inner tube region has an outer diameter of 1.6 mm and an inner diameter of 0.6 mm and the outer tube region has an internal diameter of 3.9 mm and an outer diameter of 6.4 mm. In some particular embodiments, the inner tube region extends a length beyond the end of the outer tube region, with some embodiments extending 1.5 mm beyond the end of the outer tube region. The co-axial nozzle is positioned within the reactor such that it extends into the reactant feedstock introduction portion. In particular embodiments, the co-axial nozzle extends into the reactant feedstock introduction portion at a distance of 1.6 mm. In particular embodiments, the reagent feedstock inlet is made from 1/16″ Inconel 625 tubing that penetrates the reactor section to so that the reagent feedstock is injected into the hot zone of the reactor. This design allows the the reagent feedstock to enter the reactor section chamber at subcritical temperature (e.g., 200° C.) to avoid premature hydrolysis of components in the reagent feedstock, which would otherwise lead to accelerated corrosion and plugging of the inlet lines. FIG. 4 shows a schematic illustration of a representative reagent feedstock introduction portion 400, showing representative positioning of inner tube region 402 and outer tube region 404.

The downflow hydrothermal reactor can further comprise a second zone configured for dissolving solids produced in the first zone (e.g., salts or other compounds that are not miscible in supercritical water) in a volume of water in liquid phase. In some embodiments, the second zone is located downstream of the first zone with respect to reagent feedstock flow. In such embodiments, the reagent feedstock is introduced into the top of the reactor and allowed to flow downstream to the bottom of the reactor. In some embodiments, the second zone comprises one or more injection ports positioned at the distal end of the pressure vessel configured to introduce a liquid effluent and/or a quenching solution into the pressure vessel; one or more ports configured to introduce one or more thermocouples into the second zone; one or more outlets configured to eject effluent from the hydrothermal reactor; and an effluent ejection portion positioned at the distal end of the pressure vessel. FIG. 5 provides a representative illustration of components of the second zone (500). As shown in FIG. 5, the second zone 500 can comprise injection port 502 that can be used to introduct a liquid effluent and/or a quenching solution into the pressure vessel. A thermocouple 504 also can be associated with the second zone. The second zone of FIG. 5 also includes effluent ejection portion 506, which can be detached from the pressure vessel 508, as well as outlet 510, which is configured to eject effluent from the reactor.

In an independent embodiment, the reactor can comprise a first inlet connected to the outlet of a reactant supply (such as a reagent feedstock source), optionally one or more second inlets, and an outlet. In certain embodiments, the one or more of second inlets are connected to an oxidant source, a fluid source (e.g., a source comprising water), a pilot fuel source, or any combination thereof. The first inlet and the one or more second inlets, if any, are positioned along the upper portion of the downflow reactor.

Also disclosed herein are embodiments of a system comprising the downflow hydrothermal reactor. In some embodiments, the system can further comprise, in addition to the reactor, the following components: a fuel source that is fluidly coupled to the co-axial nozzle, particularly the inner tube region of the co-axial nozzle; an oxidant source fluidly coupled to the co-axial nozzle, particularly the outer tube region of the co-axial nozzle; a reagent feedstock source that is fluidly coupled to at least one of the reagent feedstock inlets; a fluid source comprising water that is fluidly coupled to the co-axial nozzle, particularly the inner tube region of the co-axial nozzle, and/or an injection port positioned at the distal end of the pressure vessel (wherein the fluid source also acts as a liquid effluent source and/or a quenching solution source); a neutralizing agent source; one or more pumps; one or more sensors for monitoring components of the system; and one or more actuators for controlling components of the system. In independent embodiments, the fuel and oxidant can be added through individual injection inlet or nozzles and/or they can be premixed together and added through a single injection inlet or nozzle.

The fuel source typically is a container housing a fuel to be used in the reactor, such as fuels described herein. The oxidant source typically is a container housing a suitable oxidant, such as oxidants described herein. The reagent feedstock source typically comprises a substance that can contain a reagent component to be oxidized by the reactor. The system embodiments disclosed herein can be used with various feedstocks, such as biomass and sewage sludge, as well as feedstocks that can include chemical warfare agent (CWA) hydrolysates, pesticides, various industrial effluents, environmental contaminants, and other recalcitrant molecules. Exemplary reactant feedstocks can include feedstocks that may contain chemical warfare agents (or hydrolsates thereof), such as sarin (or “GB”), mustard gas (or “HD”), and the like, or a surrogate thereof (e.g., DMMP); feedstocks that may contain environmental contaminants, such as per- and polyfluoroalkyl substances; and feedstocks that may contain other toxic materials. In some embodiments, the reagent feedstock may have a significant heating value that can be used to supply thermal energy to the process. In some additional embodiments, a feedstock reagent may have flame retardant properties that lower the reaction temperature. And, in yet some additional embodiments, some waste streams (or effluent) have a very low concentration of the reagent and can act as diluent.

The fluid source typically is a container housing water and the water can be used for quenching, generating the supercritical water provided in the reactor, or both. The neutralizing agent source can be a container that houses neutralizing agent, such as a base for pH adjustment (e.g., a carbonate or other mild base) and/or a caustic agent (e.g., NaOH) that can be used to neutral acidic effluent and/or species that are produced during reactions occurring within the reactor. In some embodiments, the neutralizing agent source comprises a caustic agent can be NaOH or another suitable caustic agent.

In some embodiments, the system can further comprise one or more pumps. In some embodiments, the pumps can include High-Pressure Liquid Chromatography (HPLC) pumps. Such pumps can provide flow rates of 5-300 mL/min with maximum operating pressures of 6000-10,000 psi, well above the operating pressure of the reactor (which can be 3625 psi in some embodiments). In particular embodiments, four HPLC pumps are used to control the flow rate of the fuel, oxidant, agent, and NaOH solution. In yet some other embodiments, high pressure diaphragm or piston pumps can be used to for high flow applications so as to provide flow rates of several gallons per hour.

Sensors that can be included in the system can include the temperature monitoring components (e.g., thermocouples and/or thermowells) associated with the reactor and/or temperature monitoring components (e.g., thermocouples and/or thermowells) that are used to monitor temperatures of other components of the system, such as influent lines used to introduce materials in to the reactor. In particular embodiments, thermocouples can be positioned after the preheater on a fuel line that delivers fuel to the reactor from the fuel source; after the preheater on an oxidant line that delivers oxidant to the reactor form the oxidant source; after the preheater on a waste line that directs effluent waste from the reactor to a waste collection area; and/or on a thermowell to measure internal temperatures without contacting the fluid of the reactor. Additional sensors can include components used to analyze the pH of effluents produced in the reactor and/or the chemical composition of effluents produced in the reactor. In some such embodiments, the sensors can include a pH montoring sensor, a Raman spectrometer (e.g., an in-line Raman spectrometer; a gas chromatograph (GC) operating periodically or continuously, a total organic carbon (TOC) analyzer, an X-Ray diffraction spectrometer; an in-line spectroscopic analyzer, such as a Fourier-transform infrared spectrometer (FTIR); a capillary electrophoresis (CE) system; and/or an ion chromatography (IC) system); or other analytical instrumentation. In yet additional embodiments, pressure sensors can be used (e.g., pressure transducers). In some such embodiments, the pressure sensors can be provided between pumps and any preheaters. In certain embodiments, the one or more sensors includes a product and/or reactant concentration monitoring system. In some embodiments, such concentration monitoring system is placed in an intermediate location within the process. The product and/or reactant concentration monitoring system may spectroscopically evaluate the extent of reaction by quantifying product concentration or crystallographic structure via known analytical tools, including a Raman spectrometer, FTIR, X-Ray diffraction spectrometer, and the like.

In yet additional embodiments, the system can further comprise one or more actuators that are used to control components of the system. In some embodiments, the actuators can be used to open or close valves that facilitate controlling flow rates of components introduced into or expelled from the reactor. In particular embodiments, fluids are isolated from or distributed to pumps by solenoid valves positioned pre-pump. The actuators can be electric, pneumatic, mechanical, or any other suitable type of actuator for use with a hydrothermal reactor. In some embodiments, the one or more actuators includes one or more preheaters. The preheaters may be used to control the temperature of system inputs (e.g., inflowing temperature). In yet additional embodiments, the one or more actuators includes one or more heaters. The heaters may be used to control (e.g., increase or maintain) the temperature of the reactor. In certain embodiments, the one or more actuators includes one or more pumps. In certain embodiments, the one or more actuators includes a mass flow controller for controlling flow rates of gaseous inputs (such as compressed air, compressed O₂, etc.). In certain embodiments, the one or more actuators includes a back-pressure regulator, e.g., for controlling upstream internal system pressure. Other actuators of the disclosure may include components that can change oxidant flow, addition of diluent (water or nitrogen), reactant flow rate, inlet temperature, and the like. The choice of the actuators may be based on the model-output or map of the reaction.

In certain embodiments, the system further comprises an interface between the one or more sensors and the one or more actuators. Suitable interfaces include, but are not limited to, one or more central data acquisition modules (DAQs) for collecting signals from various sensors, a computer (.e.g., for receiving the input from the one or more sensors or DAQs and providing output to the one or more actuators), hardware for transmitting input to and output from the computer.

The system can further comprise a heater subsystem that is used to heat water to 400° C. with a constant pressure of 25 MPa. In particular embodiments, the heater subsystem is designed to transfer 2450 kJ/kg of heat to the fluid. In some embodiments, the reagent feedstock is flowed through a coiled tube around a cartridge heater. In some embodiments, 1 kW cartridge heaters can be used to heat the oxidant and fuel streams. One of the 1 kW cartridge heaters can be placed directly upstream from the air and water mixing to provide additional heating energy for the room temperature air and the water. The heaters independently can be controlled using OMEGA Platinum PID temperature controllers. Since the cartridge heaters do not have an internal thermocouple, a 1/16″ Inconel®, K-type thermocouple, can be used in some embodiments. This thermocouple can be positioned near the cartridge heater. In particular embodiments, insulation can be added around the reactor. In yet additional embodiments, the feedstock reagent inlets can be left uninsulated to dissipate heat so as to prevent leaking. In large-scale embodiments, a heater may not be needed and instead thermal energy can be provided by the fuel itself.

In particular embodiments, the reactor and/or system further comprises tubing. In some embodiments, the tubing comprises either high-pressure 316 SS tubing or high-pressure, high temperature, Inconel® 625 tubing. Fittings of the reactor typically are rated for pressures greater than 10,000 psi at room temperature. In some embodiments, rupture disks rated to 5,000 psi can be placed throughout the reactor in the event that a blockage occurs. These rupture disks can prevent the reactor from exceeding the fittings' pressure ratings and, in case of a blockage, will dump pressure and fluid into an “emergency” waste tank made from 304 SS.

FIG. 6 provides a schematic diagram of a representative system embodiment (system 600). With reference to FIG. 6, the top dotted line box includes a pilot injection portion of the system, the second dotted line box from the top shows an air injection portion of the system, the second dotted line box from the bottom shows an agent injection portion of the system, and the bottom dotted line box shows a quenching/neutralizing line portion of the system. In FIG. 6, source containers labeled “601” comprise deionized H₂O; source container labeled “602” contains a fuel; tank labeled “603” is a 6 kpsi air tank; source container labeled “604” contains a reagent feedstock; source container labeled “605” contains a neutralizing agent; pumps labeled “606,” “607,” “608,” and “609” are HPLC Pump (flow <10 mL/min, 5 mL/min, <35 mL/min, and <300 mL/min, respectively); valve labeled “610A” is a three-way solenoid valve; valve labeled “610B” is a three-way solenoid valve controlling neat agent flow via a pulse-wise signal; valve labeled “611” is a priming valve (on/off ball valve); valve labeled “612” is a check valve; disk labeled “613” is a rupture disk (>5000 psig); heater labeled “614” is a 1 kW cartridge heater; component labeled “615” is a rotameter and orifice metering valve; exchanger labeled “616” is a heat exchanger (chiller); filter labeled “617” is a 0.5 μm filter; regulator labeled “618” is a back pressure regulator (BPR); and tank labeled “619” is a 6 kpsi nitrogen tank on closed-loop system with the BPR. Control module 620 is a means for measuring input from the TCs (labeled as TC 1, TC 2, TC 3, TC 4, TC 5, and TC 6), monitoring effluent, and measuring pressure, as well as controlling actuation via pumps, flow controllers, heaters, and solenoids. The supercritical zone of reactor 622 is labeled as “SC” and the subcritical zone is labeled “subSC”

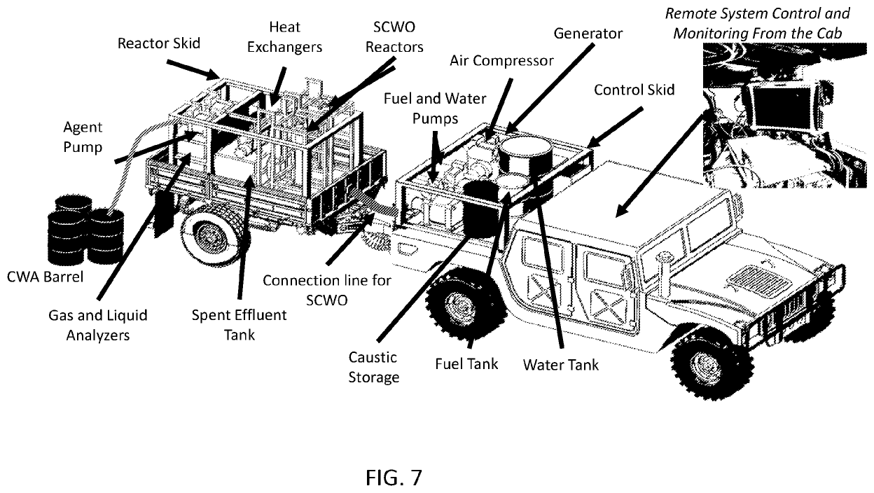

A schematic showing an exemplary portable/mobile system embodiment is shown in FIG. 7. With reference to this figure, remote operation and monitoring of the system can be used and can take place within a cab of an automobile. Certain components of the system, such as the fuel tank, water tank, compressor(s), power source, fuel and water pumps, and neutralizing agent storage can be maintained on a control skid that is housed on the automobile and thus can be easily separated and hooked-up to the reactor. Other component of the system, such as the reactor, heat exchanges, effluent tanks, analyzers, reagent feedstock pumps, and the like can be housed on a reactor skid, which can be attached to the control skid though suitable connection lines. The reactant feedstock pump can be connected to a separate reactant feedstock source, which is typically physically separated from the system as shown in FIG. 7.

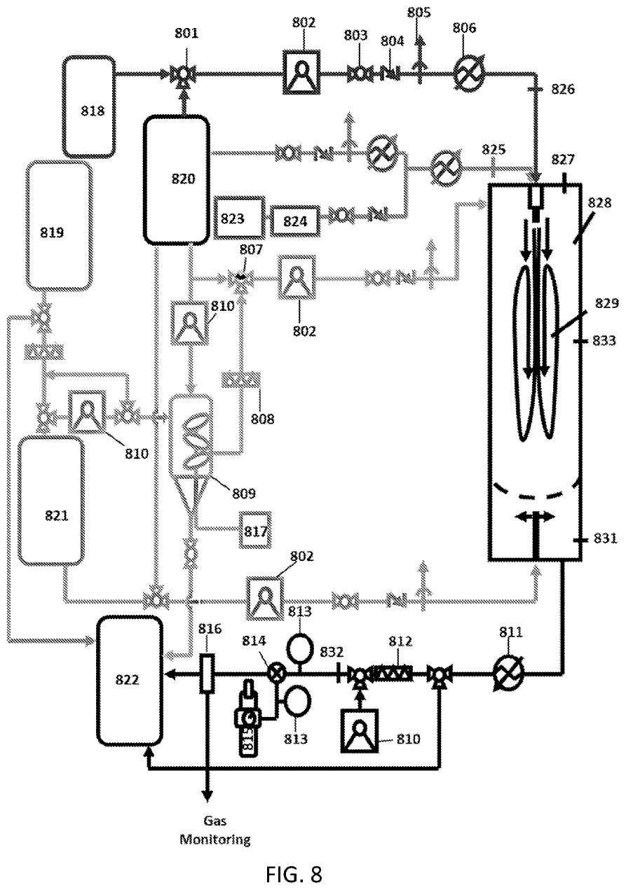

An exemplary flow diagram for an embodiment of the system is shown in FIG. 8. With reference to FIG. 8, the components include three-way solenoid valve (801), an HPLC Pump (902), a three-way solenoid valve (803), a priming valve (on/off ball valve) (804), a rupture disk (>5000 psig) (805), a 1 kW Cartridge heater (806), a three-way solenoid valve controlling neat agent flow via a pulse-wise signal (807), a filter (808), a pre-agent mixing tank (809), a low pressure pump (810), a heat exchanger (chiller) (811), a filter (812), a pressure gauge (813), a BPR (814), an N₂ tank for regulator control (815), a gas/liquid separator (816), a motor (817), a fuel source (818), an agent source (819), a fluid source (820), a neutralizing agent source (821), a waste tank (822), a compressor (823), MFC (824), an oxidant TC (825), a fuel TC (826), a reactor TC placed at the top and internally (827), an internal pressure probe (828), a TC placed in the reactor, mid fluid (829), a TC placed on the reactor wall mid-way (830), a TC placed at the bottom of the reactor (831), and a TC for the effluent (832). In some embodiments using the system of FIG. 8, water recycling can be utilized after the effluent is treated.

### Method Embodiments

In some embodiments, the method comprises operating a system as disclosed herein. The disclosed method embodiments operate at stable and safe conditions and/or achieve high conversions of the reactants. In particular embodiments, the disclosure provides method embodiments for operating a system comprising a hydrothermal reactor, one or more sensors for monitoring the reaction, and one or more actuators for controlling the reactor. In particular embodiments, the method comprises introducing an oxidant into the downflow hydrothermal reactor through an outer tube region of the co-axial nozzle; introducing a fuel into the downflow hydrothermal reactor through an inner tube region of the co-axial nozzle; igniting the fuel; and monitoring (i) temperatures detected by the one or more thermocouples of the reactant introduction portion and/or the effluent ejection portion; (ii) pH of fluids contained within the downflow hydrothermal reactor; and/or (iii) chemical make-up of fluids contained within and/or ejected from the downflow hydrothermal reactor using the one or more sensors. Also disclosed herein are embodiments of a method of conducting thermal characterization of the reactor at varied fuel dilution and preheating temperatures to determine stable operating conditions, SCWO combustion behavior, and strategies for reactor instrumentation and control.

Another aspect of the disclosure provides a method for obtaining a product from a reactant using the system of the disclosure as described herein. Such method embodiments include contacting the reactant with an oxidant in a volume of water under supercritical conditions in the reactor to form a product; receiving input from one or more sensors; and providing output to one or more actuators to control formation of the product. In certain embodiments, the input received from the one or more sensors includes the reactor temperature (e.g., internal or external), the reactor pressure, and/or concentration of the reactant, the product, or both. For example, in certain embodiments, the one or more sensors provides automated quantification of the products (e.g., liquid, solid, and/or gaseous effluents monitored by GC, TOC, Raman, etc.). Such input may be used to quantify extent of reaction. In certain embodiments, the output provided to the one or more actuators includes adjustment of mass flow rates, adjustment of the reactor temperature, adjustment of the reactor pressure, adjustment of the temperature of the incoming reactant, and/or adjustment of reactor outlets.

The methods of the disclosure as described herein may further include a real-time monitoring of the input from the one or more sensors to predict a temperature profile of the reactor. For example, predicting may be based on a sliding window of known or past temperature values. In another example, predicting may be based on an autoregressive stochastic process. Various machine learning algorithms that utilize incoming data and historical data for predicting system profiles may be used. Such prediction profiles may be used to adjust system behavior and optimize reaction conditions toward (i) maximizing reactant conversion and/or (ii) maximizing product yields. In certain embodiments, the method further comprises analyzing the temperature prediction profile to determine the output to be provided to the one or more actuators. The systems and methods of the disclosure as described herein may further include an algorithm, which can be used for controlling sensors. In some embodiments, the algorithm measures received data from the sensors and can be used to estimate the parameters needed to achieve the optimal inputs based on system response maps, process model, and the like.

In the systems and methods of the disclosure as described herein, an indicator species or an internal standard may be used. The indicator species, for example, has known reaction kinetics within the specific hydrothermal reactor regime, and its measured concentration in the effluent can be used to indirectly measure the extent of reaction of the target reaction. The indicator species preferably has a strong spectroscopic signal. The internal standard is preferably non-reactive within the specific hydrothermal reactor regime but can be added to the process at a known concentration. The known concentration can then be used to calibrate accurately and automatically one of the several spectroscopic techniques described herein for accurate quantification of other chemical species of interest.

In method embodiments disclosed herein, the one or more sensors and/or the one or more actuators provides safe/stable operation, maximizes conversion of one or more reactants, and/or maximizes yields of the reaction products. For example, temperature monitoring components used in or associated with the reactor can be used to measure temperatures of the reactor wall and/or fluid streams, which can provide information to inform the reactor operation within various parameters, such as the allowable wall temperature limits, temperature of primary oxidation region, effluent temperature, and the location of fluid transition from supercritical to subcritical region, and also allow mapping temperature distribution (axial and radial) within the reactor and on the wall of the reactor. In some embodiments, reactor wall temperature measurements can be used for estimating the fluid temperature, which would reduce the cost and increase the operational life of thermocouples, as SCWO conditions can oxidize thermocouples. In yet additional embodiments, the method can comprise evaluating other aspects of the system, such as evaluating the effluent composition to evaluate efficiency of the system and/or to determine whether operationational parameters need to be modified so as to increase or slow reactions carried out in the reactor to thereby facilitate efficiency and/or safey. In such embodiments, the method can comprise taking one or more in-situ measurements of effluent composition, including the unreacted feedstock or intermediates thereof, the fuel or any intermediates thereof. In some such embodiments, measurements can be obtained using Raman spectroscopy and other analytical techniques described herein.

In additional embodiments, the method can comprise taking a pH measurement of effluent. Such method embodiments can facilitate monitoring corrosion propensity and effluent neutralization efficacy because some reagent feedstocks will yield an acidic condition that can be monitored by pH measurement. In methods used to destroy PFAS, output parameters such as pH, ion species, or liquid/gaseous product concentrations may be used to monitor extent of reaction. For example, during the destruction of certain PFAS under hydrothermal SWCO conditions, effluent F⁻ ion concentration may be monitored by an in-line ion chromatograph, to determine extent of reaction and adjust process variables accordingly.

In yet additional embodiments, the method can comprise taking in-situ measurements of exhaust gas composition (e.g., CO or unburned hydrocarbons) to monitor oxidation efficiency thereby providing the ability to calculate the level of organic species destruction. CO is an intermediate species in the oxidation of hydrocarbons and thus monitoring this gas can provide the ability to determine whether incomplete oxidation is occurring, which can be caused by low temperature, low residence time, poor mixing, insufficient oxygen content, or combinations thereof. In some embodiments, the amount of CO also can be as a surrogate for estimation of organic compound destructions, such as with CWA destruction.

In some embodiments, the method comprises a quenching step wherein a quenching solution is added to the reactor through injection ports positioned at the distal end of the pressure vessel. In an independent embodiment, however, the method can comprise adding the quenching solution through the thermocouple ports at the head of the reactor. By rapidly quenching the SCWO reaction, the fluid spends minimum time in a transition region of the reactor, where some of the highest corrosion rates occur. This transition to subcritical also allows for any inorganic particles produced during the reaction to redissolve before continuing through the reactor, avoiding possible scaling and plugging downstream of the reactor exit. If the product of the destruction reaction is expected to be acidic, the quenching solution can be combined with a neutralizing agent, such as a base or caustic agent (e.g. aqueous NaOH), to reduce levels of corrosion downstream of the reactor exit.

In particular embodiments, the first zone of the reactor is maintained at a temperature in a range of 374° ° C. to 800° C. (e.g., in a range of 374° C. to 800° C., or 374° C. to 700° C., or 374° C. to 600° C., or 374° C. to 500° C., or 400° C. to 800° C., or 400° C. to 700° C., or 400° C. to 600° C., or 400° C. to 500° C., or or 600° C. to 800° C., or 600° ° C. to 700° C.). The first zone also can be maintained at a pressure of at least 22 MPa (e.g., at least 22.1 MPa, or at least 25 MPa, or in a range of 22 MPa to 33 MPa, or in a range of 25 MPa to 30 MPa, or in a range of 22 MPa to 50 MPa, or in a range of 25 MPa to 50 MPa).

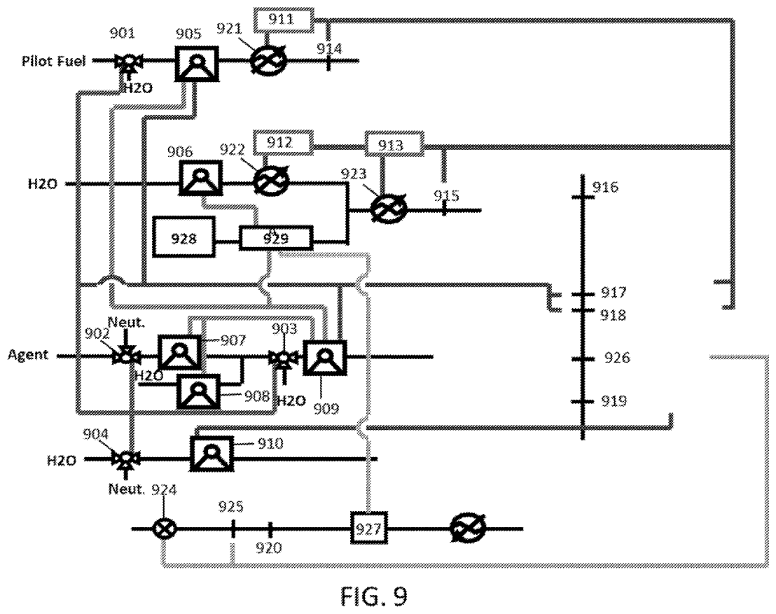

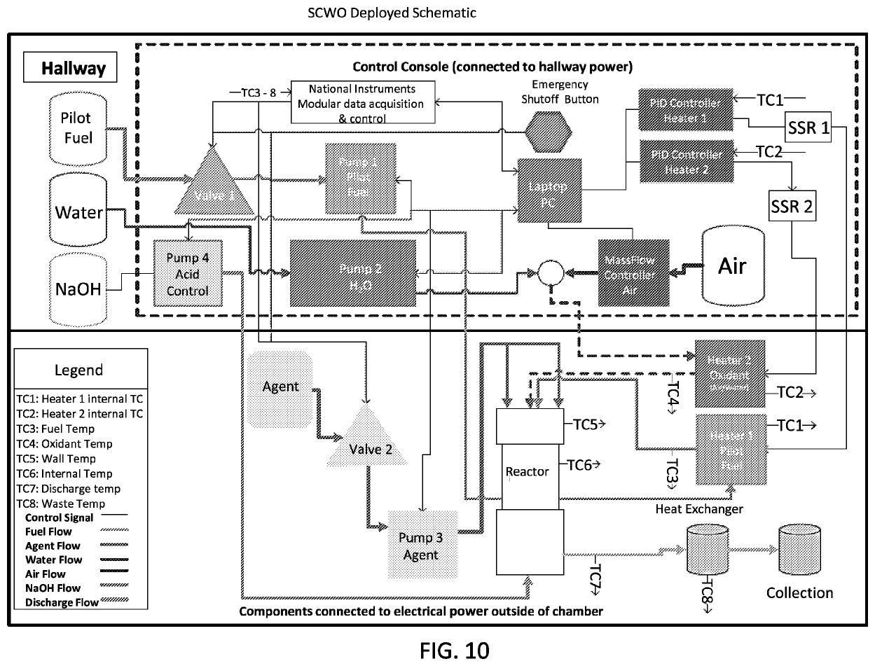

In some embodiments, the system and its components (e.g., the reactor) can be controlled remotely. To operate the reactor remotely, all manual valves and fittings were replaced with electronic versions. Additionally, all external devices not needed in the vicinity of the reactor (e.g., pumps, computer, fuel, water, etc.) can be moved to a control tower. Non-controllable pumps (e.g., Waters 515 HPLC pumps) were replaced with controllable pumps (e.g., Teledyne pumps). A control area can be connected to the reactor using suitable power cords, control wires, thermocouple extension cables, and ⅛″ 316 SS tubing. In particular embodiments, remote operation of the system can further comprise using COTS hardware, including network-capable PID controllers, data acquisition, and control elements. System operation is accomplished from a remote console incorporating parameter specification, manual run mode, system monitoring and alarms, and emergency shut down capability. The control scheme can be implemented using suitable hardware and internally and externally developed software modules. A representative control scheme is provided by the control diagram illustrated in FIG. 9. With reference to FIG. 9, solenoid valves 901, 902, 903, and 904 are used to control flow through fuel, oxidant, feedstock reagent, and neutralizing agent lines; components 905, 906, 907, 908, 909, and 910 are pumps; components 911, 912, and 913 are PID controllers; components 914, 915, 916, 917, 918, 919, and 920 are thermocouples, with 916-919 being the thermocouples associated with the reactor; components 921, 922, and 923 are heaters; components 924, 925, and 926 are pressure gauges; component 927 is a gas analyzer; 928 is a compressor; and 929 is an MFC. Pump control can be facilitated with suitable means (e.g., programmable logic controller) as well as commercially available and custom software options for data collection and component control. Additionally, external heating processes can be controlled to maintain steady-state temperatures during changes in system parameters (e.g., disturbances caused by introduction or flow rate variations of air and/or water through the system). An exemplary remotely opteration system block diagram is provided by FIG. 10.

Samples can be extracted from the system for evaluation. In some embodiments, a sampling manifold is fabricated to reduce exposure risk. In some embodiments, the sampling manifold allows for five individual samples to be taken remotely before changing the sample containers. In such embodiments, five 2-way solenoid valves are used and each sample is taken by powering one of the five valves, diverting the effluent flow into a collection containiner. The tubing between the manifold and the sample containers can be easily and quickly replaced to avoid cross-contamination between sample sets. Prior to the sampling manifold, a gas/liquid separator can be positioned to reduce splashing of the sample. Also, a gas analyzer can be used and added to the effluent gas line to monitor oxidation efficiency during operation as well as to record and analyze results later. In particular embodiments, the gas analyzer measures O₂ (in %) and CO (in ppm).

The particular system and method embodiments of the disclosure as described herein, the reactor can be a continuous-flow downflow piloted hydrothermal reactor, wherein the pilot fuel injection maintains the minimum temperature for stable reactor operation, preventing reactor blowout. If the reaction zone reaches high enough temperatures, however, the material limits can be exceeded or the reactor can enter the hydrothermal flame regime. The addition of various reactants, such as CWA or other toxic agents, may change the overall enthalpy flux and increase energetic loading of the reactor. In certain embodiments, the pilot fuel must be adjusted to accommodate the change in the overall heating value of the reagents. In certain embodiments, temperature sensor(s) information is processed by an algorithm that calculates the optimal pilot fuel rate.

Other aspects of method embodiments disclosed herein are described below.

In some embodiments, the flow rate of quenching liquid can be used to ensure the rapid transition between the supercritical region and liquid compressed water at the exit of the reactor. The liquid water is able to dissolve recalcitrant acid (such as MPA), not miscible in supercritical water. In some embodiments, the addition of a neutralizing agent, such as basic compounds or caustic compounds, to the quenching liquid allows neutralizing acid before exiting the reactor volume. Operating at neutral pH reduces corrosion downstream of the reactor-flow rates of quenching fluid need to be adjusted to ensure salts solubility in the effluent. In some embodiments, salts can be removed from the effluent using reverse osmosis (or other processes), and the water can be reused.

In some embodiments, reducing the water consumption can be achieved by recycling the effluent after its treatment, RO and other commercially available desalination can be used, however proper sizing and loading of this equipment needs to be considered. In some embodiments, an aqueous solution of EtOH is used for ignition and autogenic reactor operation. The polar nature of EtOH molecule and relatively low ignition temperature facilitates its use in small-scale laboratory reactor embodiments. Other fuels available in the field operation (e.g., gasoline, kerosene, diesel, etc.) are not water-soluble but can be implemented in the system and method embodiments disclosed herein by modifying the injection scheme for these fuels. For example, the use of high-pressure injection pumps allow injection of neat fuel into the reactor with prescribed frequency and the flow rate, reactor operation with these fuels need to be evaluated.

In some embodiments, if the chemical composition or purity of hazardous waste is not known or if the presence of solids is possible, pretreatment of feedstock before introduction to SCWO reactor can be used. These impurities may contain the product of decomposition, unknown precursors, products of corrosion. To avoid plugging the injector and feedlines, the waste-stream can be mixed with a reagent to initiate the hydrolysis or other reaction and form solid particles. The steam is then passed through the particle filter, which removes solid phase material (hydrolysis products or other particles present in the feedstock). This prefiltration treatment can be performed at lower pressure, and the filter can be replaced periodically.

In some embodiments, the flow rate or frequency/duty cycle of feedstock injection would be aimed at keeping the injector temperature below hydrolysis temperature in which formation of recalcitrant species is likely, and below the transition to supercritical fluid where these polar compounds are not soluble resulting in plugging of the injector. In some embodiments, the use of high flow diaphragm water pumps and air compressors can be implemented to achieve robust reactor operation. In such embodiments, the feedstock pumps should be compatible with high solid phase loading. A back pressure regulator can be substituted for a flow-through capillary system to reduce the influence of particle loading on pressure regulation. In some embodiments, materials with high strength at elevated temperatures are used to fabricate the reactor. In larger reactor embodiments, the walls can be cooled. In some embodiments, all connections in the hot zones are welded. In particular embodiments, a disposable reactor liner can be inserted through at the bottom of the reactor, where the temperature is significantly lower; thus, the thermal load on the seal is significantly lower.

In certain embodiments, the methods further comprise optimizing the nozzle and reactor geometry and/or tuning operational parameters. For example, such optimization may be employed to ensure safety and complete waste mineralization. In an exemplary embodiment, a small-scale, downward-flow SCWO reactor is designed and characterized under varied fuel flow rates and oxidizer flow rates. The reactor fluid of 600° C. and a corresponding residence time of 25.3 s is achieved with 7 mol % ethanol as the pilot fuel and 30 wt % H₂O₂ as the oxidant at ϕ_{AF}=1.1. These conditions are well-suited for destruction of most hazardous wastes. Maximum temperatures are observed immediately downstream of the injection nozzle at highest fuel concentrations; however, fluid temperature downstream does not change significantly with fuel dilution. Without being bound by a theory, it is believed that faster heat release and buoyancy effects increases the local temperature. Reactor characterization can be used to validate CFD models for reactor optimization. Relatively low reactor wall temperatures during operation of 7 mol % ethanol suggests possible operation with higher premixed fuel concentrations. When operating with H₂O₂, the maximum local temperature is observed at ϕ_{AF}=1.1. Operating at the lower dilution leads to a more uniform temperature profile as the reaction approached the distributed reaction region.

Limitations of small-scale reactors is the proximity of the heat release zone to the wall. Thus, in certain embodiments, the reactor material and/or wall cooling are selected as described herein and may be selected by a person of skill in the art. In certain embodiments, reactor operational envelop is optimized for flame blow-out control and reaching sufficient temperatures and residence times (e.g., even when separate reagent stream with unknown heating values is added).

### EXAMPLES

### Example 1

In this example, an embodiment of the downflow hydrothermal reactor was evaluated, namely the reactor show in FIG. 1. Preheat tests were used and showed that the reactor had far less heat loss from the fuel and oxidant preheaters to the reactor section thermocouple and could be heated to equilibrium faster. Additionally, the reactor had less variation between the experiment thermocouple readings. Initial testing was required to tune the reactor to desired destruction conditions (reactor temperature>600 C). A conservative premixed fuel concentration of 5% mol was used to find the operating conditions of the reactor. Consistent desired reactor temperatures (see Table 1) were produced, and tests with DMMP immediately followed.

TABLE 1

| | | | | | | | | | | Reactor |
|---|---|---|---|---|---|---|---|---|---|---|
| | | Oxidant Line | | | | | | | | Temperature |
| Fuel Line | | H₂O | Air | | Agent Line | | Preheat Temperatures | | | Reactor Section |
| Flow | | Flow | Flow | | Flow | | Fuel | Oxidant | Agent | Fluid - 178 mm |
| Rate | Conc. | Rate | Rate | | Rate | Conc. | Line | Line | Line | From Nozzle |
| (mL/min) | (wt %) | (mL/min) | (mL/min) | Φ_{AF} | (mL/min) | (wt %) | (C.) | (C.) | (C.) | (C.) |

| | | | | | | | | |
|---|---|---|---|---|---|---|---|---|
| 9 | 5 | 10 | 2.5 | 0 | 440 | 450 | 25 | 650 |
| | | | | (H₂O) | | | | |

Simulations were performed to test the SCWO chemistry of DMMP. A 3D domain was used to study DMMP decomposition. The analysis was done to analyze the safe operating conditions in terms of temperature and decomposition. The 4% mole case of ethanol gives a cool flame temperature of approximately 773 K when using H₂O₂, and complete ethanol oxidation occurs under these conditions. The combustion simulations with ethanol show temperatures within the permissible limit for the reactor material and sufficient to decompose DMMP. Therefore, the 4% mol boundary condition for ethanol was chosen for the DMMP decomposition simulations. The boundary conditions are given in Table 2.

TABLE 2
Parameters Used in Simulation for
Reactor Design with Air Injection

| CFD Domain: | |
|---|---|
| 2D Axisymmetric | Value |
| Inlet conditions: | |
| T_{in(oxidizer, fuel, and agent)} | 400° C. |
| T_{in, DMMP}: | 300° C. |
| Pressure | 25 MPa |
| Fuel line | 4 mol % in H₂O (10 mL/min) |
| Oxidizer line | 47.6 mol % Air in H₂O (20 mL/min) |
| DMMP (agent line) | 4 mol % DMMP in SC Water |
| | (5 mL/min) |
| Mesh Elements | ~1480000 |
| Properties: | |
| Density & Specific Heat | Piecewise-polynomial fit |
| Thermal Conductivity, | Polynomial fit |
| Viscosity | |
| Heat loss | Adiabatic Walls |
| Density, Momentum, and | First-order discretization |
| Energy | |
| K-omega turbulence model | To resolve recirculation |

To model the kinetics, a 5-step mechanism was used and is summarized in Table 3. The CFD model overpredicted the adiabatic temperature by ˜100° C. compared to the adiabatic flame temperature calculation based on the overall fuel-air equivalence ratio. The flame front where the fuel-air ratio is closer to stoichiometric should produce regions of higher temperature. The results show the complete decomposition of DMMP upon injection into the primary oxidation zone. The initial products, methanol, and MPA also further decompose into CO₂ and phosphoric acid, respectively.

TABLE 3
Reaction kinetics used in the current study

| Reactant(s) | Product(s) |
|---|---|
| C₂H₅OH + 3O₂ | 2CO₂ + 3H₂O |
| C₃H₉O₃P + 2H₂O | CH₅O₃P + 2CH₃OH |
| CH₃OH + O₂ | CO + H₂O |
| CO + 0.5O₂ | CO₂ |
| CH₅O₃P + O₂ | H₃PO₄ + H₂O + CO₂ |

Conditions suitable for agent destruction were determined experimentally. In this example, the reactor was operated using 5% mol EtOH as pilot fuel and SC wet air as an oxidant. To reach the temperatures of 675° C.(as measured at the midpoint of the reactor), the reactor boundary conditions were set to: preheating the fuel and oxidant to approximately 430° C. (+/−15° C.) with an air-to-fuel equivalence ratio of 1.1 (˜1.95 SLPM Air & 10 mL/min H2O), the fuel flow rate of 9.5 mL/min, and a reagent line flow rate 2.5 mL/min (H₂O). At these conditions, the midpoint wall temperature approaches 600° C. Due to material properties limitations, reactor wall temperatures should remain <600° C. Running the neutralizing line from 0-60 mL/min had no effect on the TCs located upstream of its location, but it influenced the temperature of the effluent.

One concern with the CWA surrogate injection is its potential decomposition before entering the reactor at higher temperatures. Formation of MPA may lead to corrosion of the injection lines. In addition, solid-phase MPA may form plugging the injection lines if SCW conditions are reached. To prevent injector line heating to hydrolysis temperature (˜350 C), continuous liquid water flow is pumped through the agent injection line, and the DMMP is introduced via a pulse into the cold water flow. The injection frequency and duration are controlled by a solenoid. The total amount of H₂O and agent introduced over 1 pulse cycle are then used to determine the overall concentration of DMMP on the continuous flow rate basis. In the analysis of DMMP mineralization, the DMMP injection is further corrected for other diluents in the system, e.g., pilot fuel, air, and water entering the SCWO reactor.

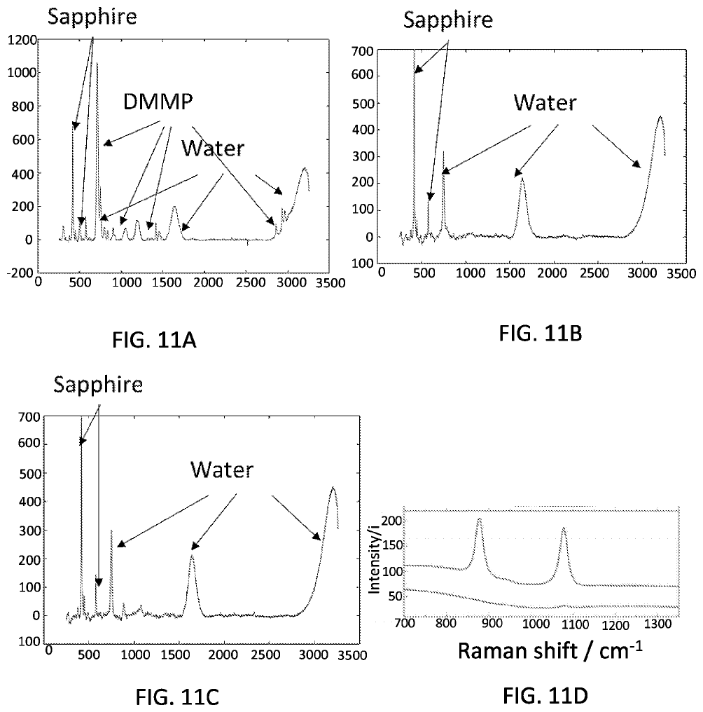

Initial evaluations validate proof of concept of the destruction of a premixed 2 wt % DMMP introduced at 2.5 mL/min with a reactor temperature of 675° C. The evaluations were performed before adding the neutralizing line, which means that residence times were slightly longer than expected when operating with the neutralizing line. No increase in temperature was observed when switching the agent line from H₂O to 2 wt % DMMP (premixed). Initial analysis using Raman Spectroscopy (FIGS. 11A-11D) shows the complete destruction of DMMP to phosphoric acid (phosphoric acid detected in FIG. 11C, as show by zoomed-in region provided by FIG. 11D).

During the destruction of DMMP, methanol (CH₃OH) is produced as an intermediate product along with MPA, as shown in Table 3. A brief study was performed to examine the effects of DMMP concentration on temperature. Neat DMMP was pulsed at long intervals to observe temperature increases. DMMP was pulsed for 10 seconds, followed by a 60-second pulse of H₂O, resulting in a temperature increase of just over 50° C. (from 640 to 695° C.). Conditions of this experiment were: fuel line=9.6 mL/min (5% mol EtOH), Air=1.9 SLPM (air-fuel equivalence 1.1 before introduction of DMMP), oxidant H₂O=10 mL/min, neutralizing line (H₂O only)=15 mL/min and agent line=2.5 mL/min. This was later calculated to be about a 16 wt % DMMP pulse; due to the large wt % and pulse length of neat DMMP, there was likely not enough O₂ in the system for complete combustion potential for a hotter reactor section. Further calculations confirm that for complete combustion, at least 2 SLPM were needed, 2.2 SLPM if the air-fuel ratio was to remain at 1.1. Due to the largely unstable nature of the temperature in the system that occurred with extended duration pulses of neat agent coupled with the need for supplemental air required for oxidation, longer pulses of neat DMMP into the reactor were deemed unfavorable. The same wt % of agent could be introduced into the reactor at shorter, more frequent time intervals which yields a more stable system. After testing, it was found that the minimum acceptable pulse width for the agent had to be >200 ms due to the infrequent pull of fluid influent from the HPLC pumps causing missed cycles.

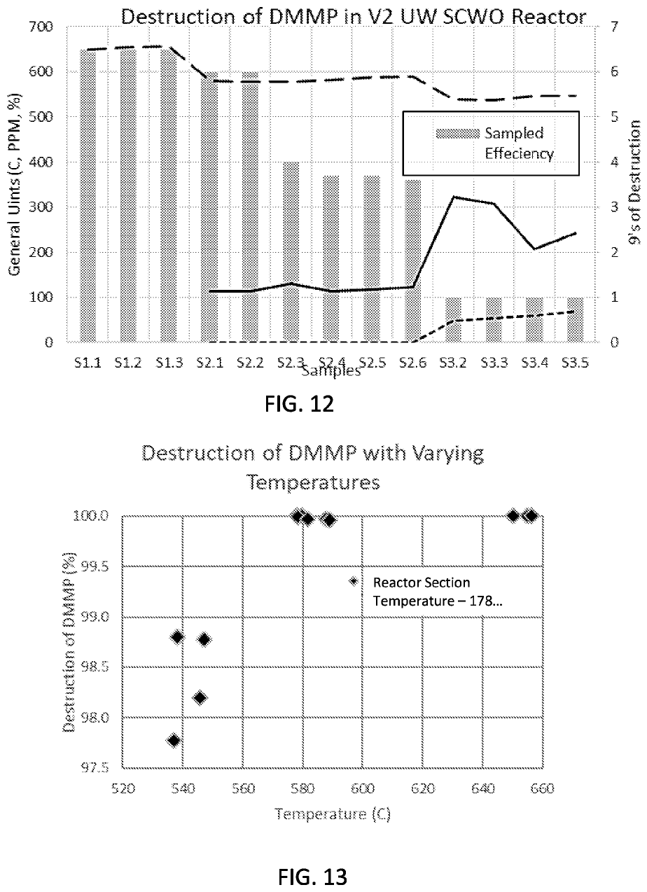

DMMP destruction was tested at concentrations ranging from 4-12 wt % and temperatures from 540-650 C with 5% mol ethanol as pilot fuel and SC-wet air as oxidant. During operation, the agent pump consistently operated at 2.5 mL/min, the neutralizing pump at 15 mL/min, and the oxidant pump at 10 mL/min. Further parameters for each of the experiments can be found in Table 4 and results summarized in FIG. 12. For consistency, only the DMMP pulse length and fuel flow rate were altered to change reactor temperature and throughput. Air flow rate was held as consistent as possible. No data was recorded for trial S1, which was operated prior to receiving the rotameter. Instead, the reactor was operated based only on an observation of the temperature profile of the reactor.

TABLE 4
Destruction of DMMP in Reactor

| | Agent Line | | | Fuel Line | Neut. Line | Air Flow Rate | |
|---|---|---|---|---|---|---|---|
| | Agent | Agent | H2O | Premix Flow | NaOH | Avg. | Air |
| ID | (wt %) | Pulse | Pulse | Rate | Conc. | Rotameter | Orifice |
| # | wt % | ms | ms | mL/min | wt % | SLPM | ×0.005″ |
| S1. 1 | 4 | 1000 | 27500 | 9 | 0 | — | — |
| S1. 2 | 4 | 1000 | 27500 | 9 | 0 | — | — |
| S1. 3 | 4 | 1000 | 27500 | 9 | 0 | — | — |
| S2. 1 | 4 | 1000 | 27500 | 7 | 0 | 6.3 | 0.7 |
| S2. 2 | 4 | 1000 | 27500 | 7 | 0.33 | 6.2 | 0.7 |
| S2. 3 | 8 | 2000 | 27500 | 7 | 0.33 | 6.2 | 0.6 |
| S2. 4 | 8 | 2000 | 27500 | 7 | 0.33 | 6.2 | 0.6 |
| S2. 5 | 8 | 2000 | 27500 | 7 | 0.33 | 7 | 0.6 |
| S2. 6 | 8 | 2000 | 27500 | 7 | 0.33 | 7 | 0.6 |
| S3. 2 | 8 | 2000 | 27500 | 5 | 0.33 | 7 | 0.6 |
| S3. 3 | 8 | 2000 | 27500 | 5 | 0.33 | 7 | 0.6 |
| S3. 4 | 12 | 3000 | 27500 | 5 | 0.33 | 7 | 0.6 |
| S3. 5 | 12 | 3000 | 27500 | 5 | 0.33 | 7 | 0.6 |

| | | | | Results of Destruction | | |
|---|---|---|---|---|---|---|
| Gas Analysis | | | Temp. | | Sampled | Theo. |
| O2 | CO | EA | TC 4 Ave. | Tested | Efficiency | Max |
| % vol | PPM | % | (C.) | ng/mL | % | % |
| — | — | — | 650.1 | 1 | 99.99995 | 99.99995 |
| — | — | — | 654.9 | 1 | 99.99995 | 99.99995 |
| — | — | — | 656.4 | 1 | 99.99995 | 99.99995 |
| 11.2 | 0 | 113 | 579.7 | 2.1 | 99.99991 | 99.99996 |
| 11.1 | 0 | 113 | 578.0 | 1.6 | 99.99993 | 99.99996 |
| 11.8 | 0 | 130 | 578.2 | 344 | 99.99264 | 99.99998 |
| 11.1 | 0 | 113 | 581.7 | 1582 | 99.96617 | 99.99998 |
| 11.3 | 0 | 118 | 587.8 | 1610 | 99.96557 | 99.99998 |
| 11.5 | 0 | 122 | 588.9 | 1678 | 99.96412 | 99.99998 |
| 14.6 | 48 | 323 | 538.3 | 62148 | 98.80089 | 99.99998 |
| 15.9 | 53 | 307 | 537.2 | 115120 | 97.77882 | 99.99998 |
| 14.2 | 60 | 207 | 545.7 | 135056 | 98.20122 | 99.99999 |
| 14.8 | 68 | 243 | 547.2 | 91551 | 98.78065 | 99.99999 |

The pilot fuel was injected into the reactor at rates between 5 and 9 mL/min to test destruction efficiency at different temperatures. Additionally, the concentration of DMMP was also varied from 4-12% wt by increasing the duration of the DMMP pulse width. Trail S1 produced complete destruction of the DMMP to no trace limits below 1 ng/ml, providing >6 “9's” of destruction while operating at 650-660C. S1 experiment was performed at the highest temperature with the lowest agent concentration. In S2.1, 6-“9,s” of destruction were also observed at the same concentration of DMMP but at a much lower temperature of 580 C; granted not to the “no detect” levels of S1. Past 4 wt % DMMP, the highest levels of destruction are 3-“9,s” at 8% at 580 C, except for S2.3; S2.3 was an outlier and reported 4-“9's”. It is believed that due to switching from 4 wt % to 8% mid trial, the lower level of destruction was likely due to a delayed response time, where the full concentration of DMMP was not yet exiting the reactor. Both 8 and 12 wt % DMMP were tested at 540C (+/−10C)(<99%) as shown in FIG. 13.

To prevent time loss, once the reactor temperature were reading as expected, the air was set and not altered from trial to trial. This caused a change in air-to-fuel when altering the pilot fuel flow rate to decrease reactor temperatures which could have impacted the results of the test. It is more likely, however, that the decrease in efficiency during S2 and S3 was due to both the increase in agent pulse width and the low operating temperatures. Without being limited to a single theory, it currently is believed that the inefficiency with the larger pulse width of DMMP is due to the need for a significant amount of O₂ in its immediate vicinity to be destroyed. Even with a large air-to-fuel ratio, this could still occur with inadequate mixing. This theory could explain the increase in CO present in trials with lower destruction efficiencies, as CO is a byproduct of the incomplete oxidation within the reactor.

### Example 2

In this example, GB and HD destruction is evaluated using a reactor embodiment. The Reaction parameters are provided by Tables 5 and 6 below.

TABLE 5
HD Evaluation Protocol

| | | | | | Fluid Mid |
|---|---|---|---|---|---|
| | O2 | | | CO | Reactor Section |
| | (%) | EA | Phi | (ppm) | (178 mm) (C.) |
| Average | | | | | |
| H1.1 | 10.18 | 195.01 | 2.95 | 5.90 | 637.73 |
| H1.2 | 9.78 | 187.91 | 2.88 | 10.19 | 639.09 |
| H1.3 | 9.57 | 184.40 | 2.84 | 9.94 | 640.36 |
| H1.4 | 10.35 | 198.12 | 2.98 | 10.40 | 646.37 |
| H1.5 | 12.35 | 244.48 | 3.44 | 10.49 | 662.05 |
| Std Dev | | | | | |
| H1.1 | 0.65 | | | 0.73 | 5.00 |
| H1.2 | 0.85 | | | 2.00 | 4.97 |
| H1.3 | 0.95 | | | 0.25 | 5.59 |
| H1.4 | 1.05 | | | 0.49 | 9.25 |
| H1.5 | 1.86 | | | 0.51 | 21.51 |

TABLE 6
GB Evaluation Protocol

| | | | | | Fluid Mid |
|---|---|---|---|---|---|
| | O2 | EA | | CO | Reactor Section |
| Average | (%) | (%) | Phi | (ppm) | (178 mm) (C.) |
| G1.1 | 12.66 | 253.52 | 3.54 | 0.00 | 642.19 |
| G1.2 | 12.69 | 254.54 | 3.55 | 61.50 | 643.84 |
| G1.3 | 13.46 | 280.76 | 3.81 | 1001.68 | 615.25 |
| G1.4 | 15.47 | 385.12 | 4.85 | 1463.00 | 603.92 |
| G1.5 | 20.56 | | | 1463.74 | 630.87 |
| G2.1 | 20.90 | | | 113.56 | 628.77 |
| G4.1 | 9.37 | 181.23 | 2.81 | 162.52 | 642.52 |
| G4.2 | 10.73 | 205.48 | 3.05 | 108.49 | 641.73 |
| G4.3 | 11.31 | 217.97 | 3.18 | 86.69 | 639.35 |
| G4.4 | 11.24 | 216.30 | 3.16 | 71.41 | 637.86 |
| G4.5 | 11.28 | 217.15 | 3.17 | 60.53 | 638.36 |
| G5.1 | 9.42 | 182.03 | 2.82 | 48.38 | 639.93 |
| G5.2 | 9.48 | 183.01 | 2.83 | 36.10 | 643.49 |
| G5.3 | 9.56 | 184.36 | 2.84 | 26.92 | 646.62 |
| G5.4 | 9.52 | 183.68 | 2.84 | 16.20 | 645.44 |
| G5.5 | 9.39 | 181.53 | 2.82 | 11.38 | 644.62 |
| G6.1 | 9.40 | 181.80 | 2.82 | 0.00 | 641.98 |
| G6.2 | 9.66 | 186.02 | 2.86 | 0.00 | 642.77 |
| G6.3 | 9.87 | 189.40 | 2.89 | 0.00 | 641.95 |
| G6.4 | 10.10 | 193.49 | 2.93 | 0.00 | 642.31 |
| G6.5 | 10.36 | 198.34 | 2.98 | 0.00 | 641.58 |
| G1.1 | 0.76 | 103.77 | 2.04 | 0.00 | 5.67 |
| G1.2 | 0.50 | 102.46 | 2.02 | 270.18 | 5.64 |
| G1.3 | 0.78 | 103.86 | 2.04 | 670.55 | 35.99 |
| G1.4 | 1.92 | 110.14 | 2.10 | 0.00 | 30.74 |
| G1.5 | 0.24 | 101.18 | 2.01 | 0.44 | 14.11 |
| G2.1 | 0.00 | 100.00 | 2.00 | 51.47 | 6.01 |
| G4.1 | 1.09 | 105.49 | 2.05 | 17.68 | 6.08 |
| G4.2 | 0.63 | 103.12 | 2.03 | 7.10 | 5.19 |
| G4.3 | 0.94 | 104.71 | 2.05 | 4.22 | 5.19 |
| G4.4 | 0.53 | 102.62 | 2.03 | 3.69 | 5.48 |
| G4.5 | 1.53 | 107.92 | 2.08 | 3.34 | 6.00 |
| G5.1 | 1.22 | 106.18 | 2.06 | 4.10 | 6.95 |
| G5.2 | 1.78 | 109.28 | 2.09 | 6.10 | 7.24 |
| G5.3 | 1.29 | 106.56 | 2.07 | 7.19 | 5.90 |
| G5.4 | 1.08 | 105.44 | 2.05 | 3.70 | 6.03 |
| G5.5 | 1.01 | 105.08 | 2.05 | 3.12 | 5.63 |
| G6.1 | 1.11 | 105.60 | 2.06 | 0.00 | 5.43 |
| G6.2 | 1.12 | 105.65 | 2.06 | 0.00 | 5.41 |
| G6.3 | 1.22 | 106.18 | 2.06 | 0.00 | 5.18 |
| G6.4 | 0.91 | 104.55 | 2.05 | 0.00 | 5.39 |
| G6.5 | 0.94 | 104.73 | 2.05 | 0.00 | 5.08 |

### Example 3

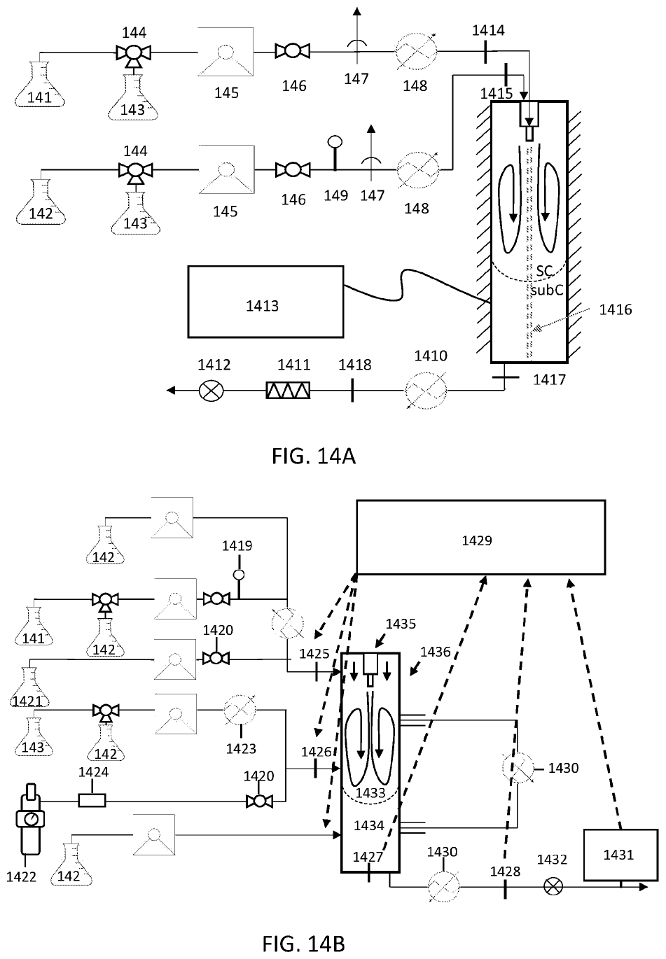

In this example, another embodiment of the hydrothermal reactor was evaluated. The SCWO reactor included two influent lines, for (i) dilute ethanol, and (ii) liquid H₂O₂. HPLC pumps introduced the influents into the reactor system, with individually selectable mass flow rates. Only H₂O was run through the system during preheating; once the desired temperatures are reached within the system, solenoid valves switched the pump influents to dilute ethanol and aqueous H₂O₂. Both influents lines were preheated by resistive cartridge heaters before injection to the main reactor section through a co-axial nozzle as described herein. FIGS. 14A and 14B show a high-level schematic of this exemplary SCWO reactor system. With reference to FIG. 14A, the components include pilot fuel source (141), H₂O for use during preheating or cooling contained in a fluid source (142), aqueous H₂O₂ (143), solenoid valves (144), pumps (145), on/off valves (146), rupture disks (147), preheaters (148), pressure gauges (149), cooling heat exchanger (1410, filter (1411), back-pressure regulator (1412), a control module (1413)and representative locations of thermocouples for process monitoring (e.g., 1414, 1415, 1416, 1417, an 1418). With reference to FIG. 14B, the system includes pilot fuel source (141), H₂O for use during preheating or cooling contained in a fluid source (142), aqueous H₂O₂ (143), pressure gauge 1419, open/close valves 1420, feedstock reagent source 1421, air compressor 1422, heater 1423, MFC 1424, thermocouples 1425, 1426, 1427, 1428, control module 1429, coolers 1430, effluent monitoring region 1431, and BPR 1432. Supercritical zone 1433 and subcritical zone 1434 also are illustrated, along a feedstock introduction region 1435, wherein fuel, oxidant, and reagent feedstock can be introduced into reactor 1436.

The reactor section included a titanium-lined vessel, with an internal volume of ˜1120 mL. The titanium liner had an inner diameter (ID) of 24.25 mm and was positioned inside a stainless steel 316 (SS316) outer tube with an ID of 25.4 mm and an outer diameter (OD) of 38.1 mm. Reagents were injected into the reactor through the co-axial nozzle at the top of the reactor. Three fuse-welded Inconel 625 spacers center the fuel line within the oxidant line, as shown in FIG. 3. After passing through the reactor section, the effluent was quenched through a heat exchanger and subsequently throttled across a back-pressure regulator (BPR), which was used to control the internal pressure. DI water (ρ=18.2 M-Ω) was used for all experiments. Aqueous H₂O₂ (30 wt % ACS Reagent Grade, Fisher Scientific) was used as the oxidant source. Reagent grade ethanol (99.8%, Fisher Scientific) was diluted with DI water to the molarity indicated in Table 7 and was used as the pilot fuel for all embodiments in this example.

TABLE 7
Initial premixed fuel concentrations and resulting
overall reactor fuel concentrations

| | | Overall Fuel Concentration | | |
|---|---|---|---|---|
| Premixed Fuel Concentration | | in Reactor Before Oxidation | | |
| % mol | % mol | % mol | % mol | % mol |
| EtOH | H₂O | EtOH | H₂O | O₂ |
| 2 | 98 | 1.2 | 95.4 | 3.35 |
| 3 | 97 | 1.53 | 94.26 | 4.21 |
| 4 | 96 | 1.76 | 93.4 | 4.83 |
| 5 | 95 | 1.93 | 92.78 | 5.29 |
| 6 | 94 | 2.06 | 92.29 | 5.66 |
| 7 | 93 | 2.17 | 91.89 | 5.95 |

The reactor section was well-insulated and instrumented with two internal Type-K thermocouples (TC 3, which is positioned within the pressure vessel from the bottom of the reactor; and TC 4 which is positioned at the distal end of the pressure vessel), and four external Type-K thermocouples, wherein three are positioned in areas similar to the external TCs shown in FIG. 2 and the fourth is positioned at the nozzle wall. TCs 1 through 4 measure internal fluid temperatures, while TCs 5 through 8 measure external wall temperatures. TC 1 (fuel line) and TC 2 (oxidant line) were positioned upstream of the nozzle. TC 3 is variously positioned 25 mm or 178 mm from the reactor nozzle, with position changed between runs to measure internal temperatures at two separate locations during operation at identical processing conditions. All influent lines are instrumented with internal Type-K thermocouples, shown in FIGS. 14A and 14B. Generally, the thermocouples are monitored continuously during each experiment, allowing for characterization of the reactor thermal profile under steady-state operating conditions and thermal response time during dynamic operation. The cooled reactor effluent was periodically analyzed with a handheld Raman spectroscopic probe to verify complete oxidation of ethanol within the reactor. The oxidant-to-fuel stoichiometric equivalence ratio (ϕ_{AF}) is defined as the percentage of molar oxygen introduced to the reaction environment, relative to the amount required for complete oxidation of the parent hydrocarbon to CO₂ and H₂O. Complete oxidation of ethanol with H₂O₂ as the oxidant is expressed as:

C₂H₅OH+6H₂O₂→9H₂O+2CO₂ (2)

With 6 mol H₂O₂ required for complete, stoichiometric oxidation of 1 mol ethanol. When H₂O₂ is the oxidant source, ϕ_{AF} can be expressed as:

$${Φ}_{A F} = \frac{{\dot{n}}_{{H}_{2} {O}_{2}} / 6}{{\dot{n}}_{ethαnol}} , \qquad ( 3 )$$

where \dot{n}_{H}_{₂}_{O}_{₂} is the molar flow rate of H₂O₂, and \dot{n}ₑₜₕₐₙₒₗ is the molar flow rate of ethanol.

Reynolds numbers are calculated for both the fuel and oxidant lines, using conservation of mass and fluid properties assuming a preheat temperature of 400° C. and pressure of 25 MPa. Assuming plug flow conditions within the reactor, nominal residence times are calculated using internal flow temperature measurements at various locations within the reactor during operation combined with the density of water at the measured temperature and pressure. Using conservation of mass, volumetric flow rates are calculated at each thermocouple location during steady state operation (TC 1, TC 2, TC 3 (25 mm), TC 3 (178 mm), and TC 4). The time for the fluid to travel from one TC to the next is then determined by averaging the respective volumetric flow rates. The sum of these times is referred to in Table 8 as the nominal residence time.

TABLE 8
Reynolds numbers and residence times for conditions corresponding to the tested fuel dilutions

| Premixed | Nominal | Flow Rate of | Flow Rate of | V of Fuel | Re of | V of Oxidant | Re of |
|---|---|---|---|---|---|---|---|
| Fuel Conc. | Residence | Fuel Pump | Oxidant Pump | at Nozzle | Fuel at | at Nozzle | Oxidant at |
| (% mol) | Time (s) | (mL/min) | (mL/min) | (m/s) | Nozzle | (m/s) | Nozzle |
| 2 | 17.6 | 13.8 | 10 | 8.16 | 17449 | 0.17 | 2090.8 |
| 3 | 21 | 9.4 | 10 | 5.52 | 11809 | 0.17 | 2090.8 |
| 4 | 23.2 | 7.2 | 10 | 4.20 | 8986 | 0.17 | 2090.8 |
| 5 | 25 | 5.9 | 10 | 3.41 | 7296 | 0.17 | 2090.8 |
| 6 | 25.1 | 5.0 | 10 | 2.88 | 6168 | 0.17 | 2090.8 |
| 7 | 25.3 | 4.4 | 10 | 2.51 | 5363 | 0.17 | 2090.8 |

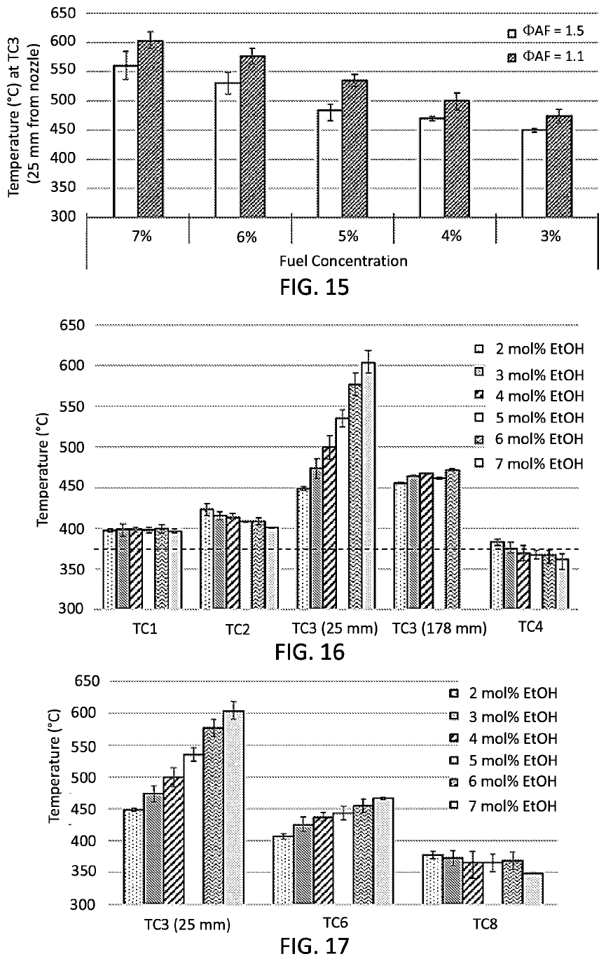

The reactor operation at ϕ_{AF} of 1.1 and 1.5 were tested using the pump flow rates presented in Table 8 to study the effect of excess O₂ in the system. At higher fuel percentages, increased ϕ_{AF} lead to larger temperature fluctuations denoted by the increasing standard deviation in FIG. 15. At higher ϕ_{AF}, lower temperatures were observed as the excess O₂ acts as a diluent. FIG. 16 shows the effect of initial ethanol dilution on the internal temperatures achieved within the SCWO reactor, with ϕ_{AF} held constant at 1.1. Although fuel concentration was varied, flow rates were adjusted to ensure constant fuel heating value into the reactor (Table 8). Internal temperature measurements were collected under steady-state operation. At least two reactor runs were performed for each condition with TC3 positioned at either 25 mm or 178 mm from the fuel nozzle. These measurements allowed profiling the reactor axially. The effluent and wall measurements were found to be in good agreement between the two runs. Higher fuel concentration resulted in a greater axial temperature gradient with the increase of maximum measured temperature near the fuel inlet. The fluid temperature near the middle of the reactor showed no significant correlation between temperature and fuel concentration, and the exit temperatures for high fuel concentration runs had the lowest likely due to the loss in the reactor.

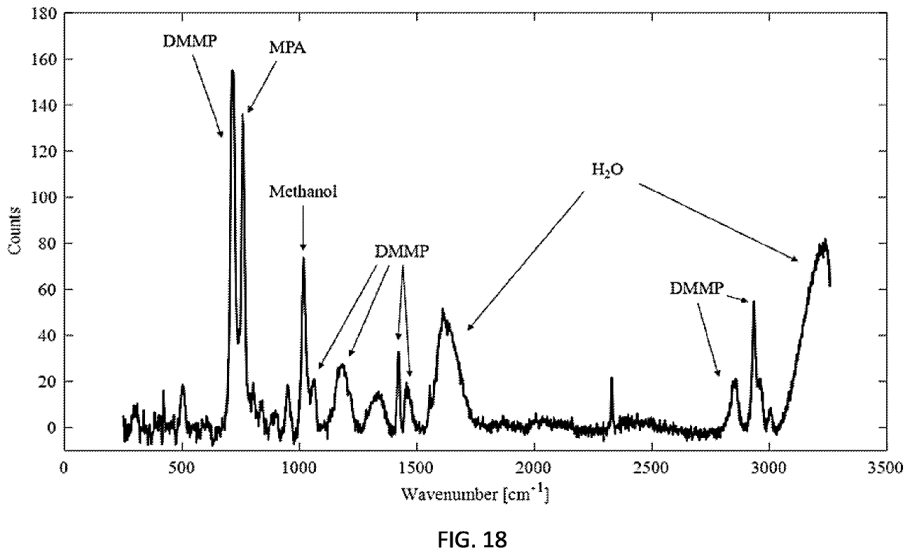

Without being bound by a theory, it is believed that increasing the increase in fuel concentration shifts the oxidizing zone upstream; the fuel is consumed more rapidly, leading to higher local temperatures. The high vertical temperature gradient has a positive gain effect as the buoyancy further amplifies the temperature stratification leading to faster reaction rates near the top of the reactor. The slow kinetics and the higher overall flow rates for the cases with lower fuel concentration show a more distributed reaction region and reduce the effect of buoyancy. This is analogous to operation combustion system that become more uniform at conditions when the flames velocities are reduced of reactor loading increases. CFD simulations confirm that increasing fuel concentration shifts the primary reacting zone toward the top of the reactor. The liquid effluent from all conditions is shown by Raman spectroscopy to contain no remaining ethanol, as shown in FIG. 18.

During operation, the external wall temperature follows the same trends observed for internal fluid temperatures. At the top of the reactor (TC 6), the reactor wall temperatures increase with the onset of the SCWO reaction (FIGS. 16 and 17). The reactor wall bottom temperatures decrease following fluid temperature trends (FIG. 16). Although the maximum fluid temperatures increased by an average of 31.9° C./mol % ethanol, the wall temperatures increased only by an average of 11.9° C./mol % ethanol. Reactor walls are rated to 600° C. due to the significant decrease in the tensile strength of SS316 at elevated temperatures. Though the fluid temperatures exceeded 600° C., reactor wall temperatures never rose above 468° C., showing the feasibility of achieving conditions suitable for the destruction of the CWA and other hazardous wastes.

In view of the many possible embodiments to which the principles of the present disclosure may be applied, it should be recognized that the illustrated embodiments are only preferred examples of and should not be taken as limiting the scope of the disclosure. Rather, the scope is defined by the following claims. We therefore claim as our invention all that comes within the scope and spirit of these claims.

1. A downflow hydrothermal reactor, comprising:
(a) a first zone configured for contacting a reactant with a volume of water under supercritical conditions to form a product and/or destroy a compound, wherein the first zone comprises
a pressure vessel having a distal end and a proximal end;
a co-axial nozzle configured to deliver a fuel and an oxidant into a reagent introduction portion; and
a reagent feedstock introduction portion positioned at the proximal end of the pressure vessel, wherein reagent feedstock introduction portion comprises (i) an opening configured to accept the co-axial nozzle, (ii) one or more reagent feedstock inlets positioned at the proximal end of the pressure vessel and that are configured to deliver a reagent feedstock into a primary reaction zone of the pressure vessel, and (iii) one or more ports configured to introduce one or more thermocouples into the reagent feedstock introduction region and/or one or more connections configured to couple a thermowell to the reagent feedstock introduction region;
(b) a second zone configured for dissolving solids in a volume of water in liquid phase, wherein the second zone is located downstream of the first zone with respect to reagent feedstock flow and wherein the second zone comprises
one or more injection ports positioned at the distal end of the pressure vessel configured to introduce a liquid effluent and/or a quenching solution into the pressure vessel;
one or more outlets configured to eject effluent from the hydrothermal reactor; and
an effluent ejection portion positioned at the distal end of the pressure vessel; and
(c) a plurality of thermocouples and/or thermowells that are physically associated with the downflow hydrothermal reactor at exterior locations between the distal end and the proximal end of the pressure vessel in the first zone.

2. The downflow hydrothermal reactor of claim 1, further comprising a replaceable liner component that is made of titanium.

3. The downflow hydrothermal reactor of claim 1, wherein the co-axial nozzle comprises an inner tube region that delivers the fuel into the downflow hydrothermal reactor and an outer tube region that delivers the oxidant into the downflow hydrothermal reactor.

4. The downflow hydrothermal reactor of claim 1, wherein the one or more reagent feedstock inlets are connected to a reagent feedstock supply, wherein the reagent feedstock supply comprises biomass, sewage sludge, a chemical warfare agent, a chemical warfare agent hydrolysate, a per- or polyfluoroalkyl substance, a pesticide, an industrial effluent, an environmental contaminant, or a combination thereof.

5. The downflow hydrothermal reactor of claim 1, wherein the first zone is maintained at a temperature of 374° C. to 800° C. and a pressure of at least 22 MPa.

6. The downflow hydrothermal reactor of claim 1, wherein the reagent feedstock introduction portion is detachable from the pressure vessel and/or the effluent ejection portion is detactable from the pressure vessel.

7. The downflow hydrothermal reactor of claim 1, wherein the downflow hydrothermal reactor is portable and/or wherein the second zone further comprises one or more ports configured to introduce one or more thermocouples into the second zone.

8. A system, comprising:
a portable downflow hydrothermal reactor comprising
(a) a first zone configured for contacting a reactant with a volume of water under supercritical conditions to form a product and/or destroy a compound, wherein the first zone comprises
a pressure vessel having a distal end and a proximal end;
a co-axial nozzle configured to deliver a fuel and an oxidant into a reagent introduction portion; and
a reagent feedstock introduction portion positioned at the proximal end of the pressure vessel, wherein the reagent feedstock introduction portion comprises (i) an opening configured to accept the co-axial nozzle, (ii) one or more reagent feedstock inlets positioned at the proximal end of the pressure vessel and that are configured to deliver a reagent feedstock into a primary reaction zone of the pressure vessel, and (iii) one or more ports configured to introduce one or more thermocouples into the reagent feedstock introduction region and/or one or more connections configured to couple a thermowell to the reagent feedstock introduction region;
(b) a second zone configured for dissolving solids in a volume of water in liquid phase, wherein the second zone is located downstream of the first zone with respect to reagent feedstock flow and wherein the second zone comprises
one or more injection ports positioned at the distal end of the pressure vessel configured to introduce a liquid effluent and/or a quenching solution into the pressure vessel;
one or more outlets configured to eject effluent from the hydrothermal reactor; and
an effluent ejection portion positioned at the distal end of the pressure vessel; and
(c) a plurality of thermocouples and/or thermowells that are physically associated with the downflow hydrothermal reactor at a fuel source fluidly coupled to the co-axial nozzle;
an oxidant source fluidly coupled to the co-axial nozzle;
a reagent feedstock source;
a fluid source comprising water;
one or more pumps;
one or more sensors for monitoring components of the system; and
one or more actuators for controlling components of the system.

9. The system of claim 8, further comprising a preprocessing unit comprising a solids filter or elutriator configured to separate solids from the reagent feedstock source prior to introducing reagent feedstock into the downflow hydrothermal reactor.

10. The system of claim 8, wherein the one or more ports of the reagent feedstock introduction portion comprises a first port and a second port and the one or more thermocouples of the reagent feedstock introduction portion comprises a first thermocouple and a second thermocouple, wherein the first port is coupled to the first thermocouple and the second port is coupled to the second thermocouple and wherein the first thermocouple is positioned so as to measure a temperature of fluid at the proximal end of the pressure vessel and wherein the second thermocouple is positioned so as to measure a temperature of fluid in the primary reaction zone of the pressure vessel.

11. The system of claim 8, wherein the one or more ports of the effluent ejection portion comprises a first port and the one or more thermocouples of the effluent ejection portion comprises a first thermocouple, wherein the first port is coupled to the first thermocouple, wherein the first thermocouple is positioned so as to measure a temperature of the effluent.

12. The system of claim 8, wherein the one or more sensors are configured to measure (i) temperatures detected by the one or more thermocouples of the reactant introduction portion and/or the effluent ejection portion; (ii) pH of fluids contained within the downflow hydrothermal reactor; and/or (iii) chemical make-up of fluids contained within and/or ejected from the downflow hydrothermal reactor.

13. The system of claim 8, wherein the system comprises the quenching solution and the quenching solution comprises a base, and wherein the system further comprising a quenching solution source fluidly coupled to the one or more injection ports positioned at the distal end of the pressure vessel.

14. The system of claim 13, wherein the actuators are configured to control fuel and/or oxidant flow rates and/or injection frequency; reagent feedstock flow rate and/or injection frequency; quenching solution flow rate and/or injection frequency; neutralizing agent introduction into the quenching solution; or a combination thereof.

15. The system of claim 8, wherein the co-axial nozzle comprises an inner tube region configured to deliver a fuel into the downflow hydrothermal reactor and an outer tube region configured to deliver an oxidant into the downflow hydrothermal reactor.

16. A method of using the downflow hydrothermal reactor system of claim 8 for supercritical water oxidation, comprising:
introducing an oxidant into the downflow hydrothermal reactor through an outer tube region of the co-axial nozzle;
introducing a fuel into the downflow hydrothermal reactor through an inner tube region of the co-axial nozzle;
igniting the fuel; and
monitoring (i) temperatures detected by the one or more thermocouples of the reactant introduction portion and/or the effluent ejection portion; (ii) pH of fluids contained within the downflow hydrothermal reactor; and/or (iii) chemical make-up of fluids contained within and/or ejected from the downflow hydrothermal reactor using the one or more sensors.

17. The method of claim 16, wherein the method further comprises:
(i) using one of the one or more actuators to adjust flow rate and/or injection frequency of the oxidant;
(ii) using one of the one or more actuators to adjust flow rate and/or injection frequency of the fuel so as to control the position of the primary reaction zone within the pressure vessel;
(iii) using one of the one or more actuators to adjust flow rate and/or injection frequency of the reagent feedstock so as to control an oxidation process that occurs within the pressure vessel, or to control temperature of the first zone, and/or or to control reagent feedstock temperature as reagent feedstock enters the downflow hydrothermal reactor such that the temperature is maintained below hydrolysis temperature to avoid plugging;
(iv) using one of the one or more actuators to adjust flow rate and/or injection frequency of the quenching solution so as to factilitate transition of supercritical water in the pressure vessel to liquid compressed water, thereby dissolving by-products from the supercritical water in the liquid compressed water;
(v) pretreating the reagent feedstock by treating the reagent feedstock with an effluent produced by the downflow hydrothermal reactor and/or filtering solids from the reagent feedstock; or
(vi) any combination of (i)-(iv).

18. The method of claim 16, wherein the fuel comprises an alcohol; an alcohol and water mixture; a liquid fuel selected from gasoline, kerosene, and/or diesel; or a liquid fuel and water mixture, wherein the liquid fuel is selected from gasoline, kerosene, and/or diesel.

19. The method of claim 18, wherein the method further comprises desalinating and/or recycling any water from the effluent.

20. The method of claim 16, wherein the reagent feedstock comprises biomass, sewage sludge, a chemical warfare agent, a chemical warfare agent hydrolysate, a per- or polyfluoroalkyl substance, a pesticide, an industrial effluent, an environmental contaminant, or a combination thereof.
